(19) United States
(12) Patent Application Publication
(10) Pub. No.: US 2009/0129576 A1
(43) Pub. Date: May 21, 2009

(54) RELAY DEVICE, COMMUNICATION TERMINAL, SIGNAL DECODER, SIGNAL PROCESSING METHOD, AND SIGNAL PROCESSING PROGRAM

(75) Inventors: Tomofumi Yamanashi, Tokyo (JP); Kaoru Satoh, Kanagawa (JP); Toshiyuki Morii, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/995,718

(22) PCT Filed: Jul. 14, 2006
(86) PCT No.: PCT/JP2006/314039

§ 371 Date: Jan. 15, 2008

(30) Foreign Application Priority Data
Jul. 19, 2005 (JP) 2005-208933

(51) Int. Cl. H04M 3/42; G10L 19/00

(52) U.S. Cl. 379/202.01; 704/500

(57) ABSTRACT

It is an object of the present invention to provide a relay device, a communication terminal, a signal decoder, a method for processing a signal, and a program for processing a signal, which make it possible to achieve a multi-party communication system capable of preventing a significant deterioration of the quality of a sound obtained by decoding a speech/audio signal without increasing a cost for processing, as compared with the conventional communication terminals, the conventional communication techniques, and the like. The relay device comprises a receiver 11 for receiving information transmitted from a plurality of communication terminals participating in multi-party communications and encoded on a layer basis in a plurality of layers by scalable coding; a reconstruction processor 15 for generating control information used to combine, on a layer basis, the encoded information received by the receiver 11 from the plurality of communication terminals; and an integrator/transmitter 16 for integrating, on a layer basis, the encoded received by the receiver 11 from the plurality of communication terminals in accordance with the control information generated by the reconstruction processor 15.

### TECHNICAL FIELD OF THE INVENTION

The present invention relates to a relay device, a communication terminal, a signal decoder, a method for processing a signal, and a program for processing a signal, which are used in a communication system for encoding and transmitting a signal.

### BACKGROUND OF THE INVENTION

Conventionally, there have been known a wide variety of multi party communication systems each of which performs simultaneous communications between three or more parties, such as a multipoint conferencing system, and is widely used in recent years. Each of the communication systems, such as a digital communication system for performing communications through Integrated Services Digital Network (ISDN) or the like, performs communications between multiple parties by assigning a speech/audio signal transmitted from each of terminals to a unique channel on the basis of each of the terminals and by transmitting a signal to each of the terminals through a communication line.

Aside from the above-mentioned multi-party communication systems, another typical communication system has a function allowing communication devices such as an exchange, a communication server, and a telephone device to perform multi-party communications. Each of the communication devices such as an exchange decodes signals transmitted from multiple terminals to overlap the decoded signals. Each of the communication devices then re-encodes the signals to transmit each of the encoded signals to a specified terminal. The telephone device is designed to receive a signal transmitted from each of other terminals and decodes the received, overlap the received speech/audio signals, and encode the overlapped signal to transmit the encoded signal to the exchange, if the telephone device has a function for performing multi-party communications. The above mentioned communication technique for performing multi-party communications is described in, for example, Patent Document 1.

In recent years, scalable coding techniques have been developed, which are each capable of decoding a speech/audio signal or a music signal from part of encoded information and suppressing a deterioration of the quality of a sound even in the case where a packet is lost (for example, refer to Patent Document 2). The scalable coding technique disclosed in Patent Document 2 is designed to encode a speech/audio signal or a music signal in multiple layers in order to decode the audio signal or the music signal from part of encoded information. The scalable coding technique can suppress a deterioration of the quality of a sound even in the case where a packet is lost. Specifically, if the scalable coding technique is designed to encode an input signal firstly in a first layer, which is the lowest layer among multiple layers, the technique is to generate encoded information to be input to a first layer. The scalable coding technique is designed to then repeat a step of receiving a residual signal indicating a difference between a signal input to an (i−1)th layer (i is an integer equal to or more than 2) and a decoded signal obtained by decoding encoded information input to the (i−1)th layer, and a step of encoding the residual signal to generate information to be input to an ith layer.

### Patent Document 1: Japanese Patent Laid Open Publication No. 2004-222194

### Patent Document 2: Japanese Patent Laid Open Publication No. 10-97295

### DISCLOSURE OF THE INVENTION

### Problems to be Resolved by the Invention

Such a conventional telephone device having a function for performing multi-party communications, however, is designed to decode received encoded information, overlap the decoded signal with a speech/audio signal, and re-encode the overlapped signal, which results in a large cost required for the calculation and in a deterioration of the quality of a sound obtained by decoding a speech/audio signal encoded a plurality of times. If the number of communication lines increases with increasing the number of communication terminals participating in multi-party communications, the communication cost would increase, and the usage rate of lines would also increase, causing a problem of operability of the system.

It is, therefore, an object of the present invention to provide a relay device, a communication terminal, a signal decoder, a method for processing a signal, and a program for processing a signal, which make it possible to achieve a multi-party communication system capable of preventing a significant deterioration of the quality of a sound obtained by decoding a speech/audio signal without increasing a cost for processing, as compared with the conventional communication terminals, the conventional communication techniques, and the like.

### Means for Solving the Problems

There is provided a relay device according to the present invention comprising: a receiver for receiving information transmitted from each of communication terminals participating in multi-party communications and encoded on a layer basis in a plurality of layers by scalable coding; a reconstruction processor for generating control information used to combine the encoded information received by the receiver from the communication terminals, on the basis of each of the plurality of layers; an integrator/transmitter for combining and integrating, in accordance with the control information generated by the reconstruction processor, the encoded information received by the receiver from the communication terminals, on the basis of each of the plurality layers, and transmitting the integrated encoded information.

The relay device thus constructed as described above according to the present invention reconstructs received encoded information to transmit the reconstructed information without decoding. This prevents an increase in cost for processing, compared with the conventional communication terminals, the conventional communication techniques and the like. The relay device according to the present invention makes it possible to achieve a multi-party communication system capable of preventing a significant deterioration of the quality of a sound obtained by decoding a speech/audio signal.

The reconstruction processor of the relay device according to the present invention may have a control parameter storage section for storing a control parameter including a transmission bit rate of a signal transmitted in the past. In this case, the transmission bit rate is in the state of being set for each of the communication terminals. The reconstruction processor of the relay device according to the present invention may generate control information used to combine the encoded information to be transmitted to the communication terminals in accordance with a control parameter stored in the control parameter storage section.

The relay device thus constructed as described above according to the present invention is capable of reducing a load of processing for detecting a transmission bit rate and generating control information, since the reconstruction processor is designed to generate control information used to combine encoded information to be transmitted to each of communication terminals in accordance with the control parameter including a transmission bit rate of a signal transmitted in the past.

The reconstruction processor of the relay device according to the present invention may set the control parameter stored in the control parameter storage section in accordance with the level of a speech/audio signal to be reproduced based on each of the encoded information transmitted from the communication terminals and with information on communication conditions including the statuses of communication lines for communications between the relay device and the communication terminals

The relay device thus constructed as described above according to the present invention makes it possible to achieve the configuration of layers leading to reproduction of a speech/audio signal to output a sound comfortable on the side of a listener, since the reconstruction processor is capable of setting the control parameter in accordance with the level of a speech/audio signal to be reproduced and with the information on communication conditions including the statuses of communication lines.

The reconstruction processor of the relay device according to the present invention may be designed to update the control parameter stored in the control parameter storage section when another communication terminal participates in the multi-party communications or when any one of the communication terminals participating in the multi-party communications cancels the participation of the multi-party communications.

The relay device thus constructed as described above according to the present invention is capable of reducing a load of processing for generating control information, since the reconstruction processor is designed to update the control parameter stored in the control parameter storage section.

The reconstruction processor of the relay device according to the present invention may be designed to select information encoded on the basis of each of a predetermined number of layers including a base layer from the encoded information received from the communication terminals in accordance with the control parameter stored in the control parameter storage section to combine the selected information.

The relay device thus constructed as described above according to the present invention is capable of reducing the load of processing for generating control information, since the reconstruction processor is designed to select the encoded information in accordance with the control parameter.

The relay device according to the present invention may comprise encoded information storage section for sequentially storing encoded information transmitted in the same time zone by any of the communication terminals and then storing encoded information transmitted in the next time zone by any of the communication terminals, in which every time the encoded information storage section receives the encoded information transmitted from two or more of the communication terminals participating in the multi-party communications in the same time zone, the encoded information storage section outputs, to the reconstruction processor, the encoded information sequentially stored in the encoded information storage section and not output yet to the reconstruction processor.

The relay device thus constructed as described above according to the present invention makes it possible to clarify the processing, since the encoded information storage section is designed to receive encoded information transmitted in the same time zone and then receive encoded information transmitted in the next time zone.

The relay device according to the present invention may be designed to connect any one of the communication terminals, with another communication terminal by use of a communication line other than a line used to perform the multi-party communications, and then to cause the other communication terminal to participate in the multi-party communications.

The relay device thus constructed as described above according to the present invention is designed to connect two communication terminals relating to the interrupt by use of a communication line other than the line used to perform the multi-party communications. The relay device according to the present invention is thus capable of performing processing relating to an interrupt without a suspension of the multi-party communications.

The relay device according to the present invention may be designed to connect any one of the communication terminals participating in the multi-party communications with another communication terminal by use of a communication line other than the line used to perform the multi-party communications to communicate the any one of the communication terminals participating terminal with the other communication terminal.

The relay device thus constructed as described above according to the present invention is designed to connect two communication terminals relating to the interrupt by use of a communication line other than the communication lines used to perform the multi-party communications. The relay device according to the present invention is thus capable of performing processing relating to an interrupt without a suspension of the multi-party communications.

The communication terminal according to the present invention may comprise: a receiver for receiving information encoded on the basis of each of a plurality of layers by scalable coding; a decoder for decoding a speech/audio signal by scalable coding in accordance with control information included in the encoded information received by the receiver; an encoder for encoding the speech/audio signal by scalable coding in accordance with the control information included in the encoded information received by the receiver; and a transmitter for transmitting the information obtained by encoding the speech/audio signal.

The relay device thus constructed as described above according to the present invention is designed to reconstruct received encoded information and transmit the reconstructed information without decoding. This prevents an increase in cost for processing, compared with the conventional communication terminals, communication techniques and the like. The relay device according to the present invention makes it possible to achieve a multi-party communication system capable of preventing a significant deterioration of the quality of a sound obtained by the decoding.

The signal decoder according to the present invention may comprise an encoded information separator for separating information encoded on the basis of each of a plurality of layers by scalable coding into encoded information of each layersource code and control information; and a decoder for decoding the encoded information on the basis of each of the plurality of layers and in accordance with the control information.

The signal decoder thus constructed as described above is capable of decoding encoded information on a layer basis in accordance with the control information, and decoding encoded information transmitted from a different communication terminal and integrated in a different layer.

The decoder of the signal decoder according to the present invention may be designed to decode the information encoded on the basis of each of a predetermined number of layers including a base layer.

The signal decoder thus constructed as described above according to the present invention is capable of accurately decoding information encoded on a layer basis from in the base layer even when the transmission bit rate is low.

There is provided a method for processing a signal, according to the present invention, comprising: a reception step of receiving, by a receiver, encoded information transmitted from plurality of communication terminals participating in multi-party communications and encoded on the basis of each of a plurality of layers by scalable coding; a reconstruction step of generating control information used to combine, on a layer basis, the encoded information received from the plurality of communication terminals in the reception step; an integration step of combining and integrating, on a layer basis, the information received from the plurality of communication terminals and encoded on the basis of each of the plurality of layers, by use of an integrator/transmitter; and a transmission step of transmitting the information encoded on the basis of each of the plurality of layers and integrated in the integration step, by use of the integrator/transmitter.

The relay device constructed using the abovementioned method according to the present invention is designed to reconstruct received encoded information to transmit the reconstructed information without decoding. This prevents an increase of a cost necessary for processing, compared with the conventional communication terminals, communication techniques and the like. The relay device according to the present invention may perform the above-described method for processing a signal to achieve a multi-party communication system capable of preventing a significant deterioration of the quality of a sound signal obtained by the decoding.

There is provided a program for processing a signal, according to the present invention, comprising: a reception step of receiving encoded information transmitted to a computer from a plurality of communication terminals participating in multi-party communications and encoded on the basis of each of a plurality of layers by scalable coding; a reconstruction step of generating control information used to combine, on a layer basis, the encoded information received from the plurality of communication terminals in the reception step; an integration step of combining and integrating, on a layer basis, the encoded information received from the plurality of communication terminals and encoded on the basis of the plurality of layers; and a transmission step of transmitting the encoded information integrated in the integration step.

The program for processing a signal according to the present invention, which is designed to execute the above-described steps, reconstructs received encoded information to transmit the reconstructed information without decoding. This prevents an increase in cost for processing, compared with the conventional communication terminals, communication techniques and the like. The relay device according to the present invention makes it possible to achieve a multi-party communication system capable of preventing a significant deterioration of the quality of a sound signal obtained by the decoding.

The present invention provides a relay device designed to reconstruct received encoded information to transmit the reconstructed information without decoding, a communication terminal, a signal decoder, a method for processing a signal, and a program for processing a signal. This prevents an increase in cost for processing, compared with the conventional communication terminals, communication techniques and the like. The relay device according to the present invention makes it possible to achieve a multi-party communication system capable of preventing a significant deterioration of the quality of a sound signal obtained by the decoding.

### BRIEF DESCRIPTION OF THE DRAWINGS

FIG. 1 is a block diagram showing the configuration of a communication system including a relay device and communication terminals according to the first embodiment of the present invention.

FIG. 2 is a block diagram showing the configuration of the relay device according to the first embodiment of the present invention.

FIG. 3 is a block diagram showing the configuration of a first interrupt pattern processing unit according to the first embodiment of the present invention.

FIG. 4 is a block diagram showing the configuration of a second interrupt pattern processing unit according to the first embodiment of the present invention.

FIG. 5 is a block diagram showing the configuration of a third interrupt pattern processing unit according to the first embodiment of the present invention.

FIG. 6 is a flowchart showing operations of the relay device according to the first embodiment of the present invention.

FIG. 7 is a flowchart showing a first interrupt pattern process performed by the first interrupt pattern processing unit according to the first embodiment of the present invention.

FIG. 8 is a flowchart showing a second interrupt pattern process performed by the second interrupt pattern processing unit according to the first embodiment of the present invention.

FIG. 9 is a flowchart showing a third interrupt pattern process performed by the third interrupt pattern processing unit according to the first embodiment of the present invention.

FIG. 10 is a block diagram showing the configuration of a communication terminal according to a second embodiment of the present invention.

FIG. 11 is a block diagram showing the configuration of a decoder according to the second embodiment of the present invention.

FIGS. 12(a) to 12(d) are diagrams each showing a data structure of encoded information to be transmitted from the communication terminal according to the second embodiment of the present invention.

FIG. 13 is a block diagram showing an inner configuration of a base layer encoder of an encoder according to the second embodiment of the present invention.

FIG. 14 is a block diagram showing an inner configuration of a base layer decoder of the encoder according to the second embodiment of the present invention.

FIG. 15 is a block diagram showing an inner configuration of a decoder provided in the communication terminal according to the second embodiment of the present invention.

### DESCRIPTION OF REFERENCE NUMERALS

1A to 1N: Communication terminal
2A to 2N: Transmission channel
10: Relay device
11: Receiver
12: Interrupt determination section
13: Encoded information separator
14: Encoded information managing section (encoded information storage section)
15: Reconstruction processor
15a: Control parameter storage section
16: Integrator/transmitter
16 encoded information integrator
16b: Transmitter
18a, 18b, 39a, 39b, 39c, 44, 134, 136, 138, 201, 202, 203, 222a, 222b, 224a, 224b, 226a, 226b: Control switch
19: Communication processor
20, 30, 40: Interrupt pattern processing unit
21, 34, 41: Terminal number determination section
22, 26, 27, 32, 36, 38, 43: Pattern switching processor
23, 31: Connection preparation section
24, 33: Permission determination section

### BEST MODE FOR CARRYING OUT THE INVENTION

Embodiments of the present invention will be described below with reference to the accompanying drawings.

### First Embodiment

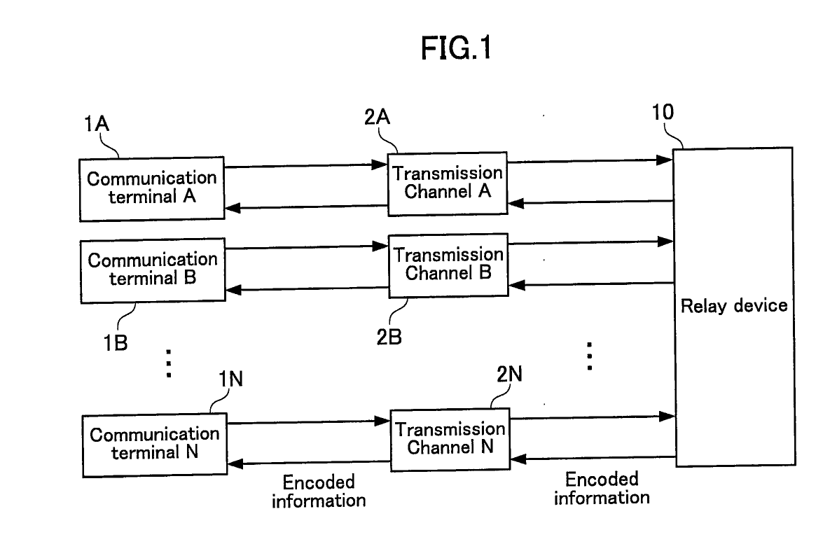

FIG. 1 is a block diagram showing the configuration of a communication system including a relay device and communication terminals according to the first embodiment of the present invention. The communication system shown in FIG. 1 includes a plurality of communication terminals 1A to 1N and the like capable of performing multi-party communications, a relay device 10, a plurality of transmission channels for connecting the plurality of communication terminals 1A to 1N and the like with the relay device 10, in which the plurality of communication terminals 1A to 1N can mutually perform multi-party communications through the relay device 10.

The relay device 10, which has a function for enabling multi-party communications and is provided in the communication system, will be described. Communications between two terminals are similar to those in the conventional technique and are not described. Code-excited linear prediction (CELP) is used for hierarchical coding and decoding.

The layers are referred to as “a base layer”, “a first enhancement layer”, “a second enhancement layer”, “a third enhancement layer” and the like in the order from the lowest layer. The layers other than the base layer are referred to as enhancement layers. The hierarchical encoding and decoding make it possible to ensure scalability, since data in all layers is transmitted when a bit rate expressing a communication rate is significantly achieved, and since data in the predetermined number of layers from the base layer, which are determined in accordance with the bit rate, is transmitted when a significant bit rate is not achieved.

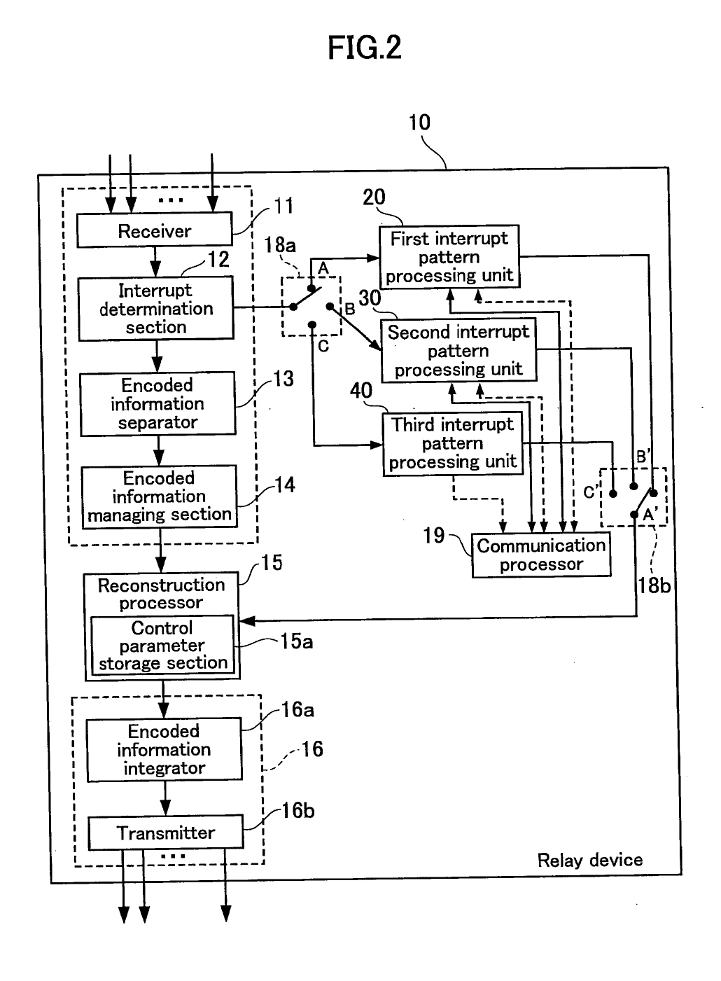

The FIG. 2 is a block diagram showing the configuration of the relay device 10 according to the first embodiment of the present invention. The relay device 10 has a receiver 11 for receiving a signal transmitted from each of the plurality of communication terminals 1A to 1N and the like; an interrupt determination section 12 for determining whether or not the received signal includes an interrupt signal; first, second and third interrupt pattern processing units 20, 30, 40 for executing interrupt processing in accordance with the interrupt signal; an encoded information separator 13 for sequentially separating predetermined information from encoded information (hereinafter referred to as received encoded information) included in the received signal; an encoded information managing section 14 for managing the information sequentially separated from the received signal by the encoded information separator 13; a reconstruction processor 15 for reconstructing encoded information to be transmitted to the plurality of communication terminals 1A to 1N and the like; an encoded information integrator 16a for integrating the reconstructed encoded information; a transmitter 16b for transmitting the integrated encoded information to the plurality of communication terminals 1A to 1N and the like; control switches 18a and 18b for switching a connection in accordance with the interrupt signal; and a communication processor 19 for connecting and disconnecting a line. The encoded information integrator 16a and the transmitter 16b are collectively referred to as an “integrator/transmitter 16.” According to the first embodiment, the reconstruction processor 15 has a control parameter storage section 15a. The control parameter storage section 15a may be a storage region capable of maintaining, updating and deleting a control parameter, for example a non-volatile storage medium such as a hard disk and a flash memory.

The receiver 11 receives a signal transmitted from each of the plurality of communication terminals 1A to 1N and the like through a plurality of transmission channels 2A to 2N and outputs the received signal to the interrupt determination section 12.

The interrupt determination section 12 receives the signal transmitted from the receiver 11 and determines whether or not the received signal includes an interrupt signal used to connect or disconnect any one of communication terminals and to increase or decrease the number of the communication terminals participating in multi-party communications. If the interrupt determination section 12 determines that the received signal includes the interrupt signal, the interrupt determination section 12 outputs the interrupt signal to the interrupt pattern processing unit 20, 30 or 40 in accordance with the pattern of the interrupt signal. If the interrupt determination section 12 determines that the received signal does not include the interrupt signal, the interrupt determination section 12 outputs the received signal to the encoded information separator 13.

Hereinafter, the multi-party communications are performed between the communication terminals 1A to 1N unless stated otherwise. The interrupt signal has first, second and third patterns. The first pattern interrupt signal (hereinafter referred to as the first pattern interrupt signal) includes a participation request signal designed to be transmitted from any one of the communication terminals 1A to 1N when the any one of the communication terminals 1A to 1N causes a communication terminal 1Z other than the communication terminals 1A to 1N to participate in the multi-party communications during the multi-party communications performed by the communication terminals 1A to 1N. The second pattern interrupt signal (hereinafter referred to as the second pattern interrupt signal) is a participation request signal designed to be transmitted from the communication terminal 1Z other than the communication terminal 1A to 1N to request any one of the communication terminal 1A to 1N to communicate with the communication terminal 1Z during the multi-party communications performed by the communication terminals 1A to 1N. In the present embodiment, the communication terminal 1A is used as a terminal with which the communication terminal 1Z requests to communicate, to facilitate understanding. The third pattern interrupt signal (hereinafter referred to as the third pattern interrupt signal) is a line disconnection request signal designed to be transmitted from any one of the communication terminals 1A to 1N participating in the multi-party communications when the any one of the communication terminals 1A to 1N requests to cancel the participation of the multi-party communications during the multi-party communications. In the present embodiment, the communication terminal 1N is used as a terminal that requests to cancel the participation of the multi-party communications. If the interrupt determination section 12 determines that the received signal includes the first pattern interrupt signal, the interrupt determination section 12 operates to connect the control switches 18a and 18b to terminals A and A′ respectively and to output the first pattern interrupt signal to the first interrupt pattern processing unit 20 as shown in FIG. 2.

The encoded information separator 13 receives the signal output from the interrupt determination section 12 and sequentially separates received encoded information included in the received signal into a component of encoded information (hereinafter referred to as a “encoded information component”) and a component of control information (hereinafter referred to as a “control information component”) to output the sequentially separated encoded information component and the sequentially separated control information component to the encoded information managing section 14.

The encoded information is speech/audio information encoded, such as content of speech/audio data transmitted from the communication terminals 1A to 1N. The control information is information (hereinafter referred to as “terminal transmission mode information”) on a transmission bit rate of a signal transmitted by each of the communication terminals 1A to 1N, information relating to the encoded information, error correction information, and error detection information.

The encoded information managing section 14 receives the encoded information component and the control information component, which are output from the encoded information separator 13. The encoded information managing section 14 sequentially accumulates the encoded information component and the control information component transmitted in the same time zone from the communication terminals 1A to 1N participating in the multi-party communications to manage the encoded information component and the control information component. The encoded information managing section 14 outputs, to the reconstruction processor 15, the encoded information and the control information which are sequentially accumulated, when the encoded information managing section 14 receives the encoded information components and the control information components which are obtained by separating encoded information transmitted from two or more of the plurality of communication terminals 1A to 1N in the same time zone. The encoded information managing section 14 constitutes an encoded information storage section in the present embodiment.

The reconstruction processor 15 receives the encoded information and the control information, which are output from the encoded information managing section 14 and transmitted in the same time zone, and an output (hereinafter referred to as an “interrupt processing output signal”) from the interrupt pattern processing units 20, 30 and 40. The reconstruction processor 15 reconstructs the encoded information and the control information, which are to be transmitted to the communication terminals 1A to 1N and the like, and outputs, to the encoded information integrator 16a, information (encoded information and control information) obtained by reconstructing the encoded information and the control information. The control parameter is a predetermined parameter and is set in the relay device 10. The control parameter includes a transmission bit rate of a signal to be transmitted to each of the communication terminals 1A to 1N and the like. In this case, the transmission bit rate is in the state of being set for each of the communication terminals 1A to 1N. The reconstruction processor 15 has the control parameter storage section 15a for setting the control parameter in the present embodiment. The present invention, however, is not limited to the control parameter storage section 15a. The control parameter storage section 15a may be provided in any section other than the reconstruction processor 15 in the relay device 10 as long as the control parameter storage section 15a is a storage medium capable of maintaining, updating, and deleting the control parameter. The control parameter is updated in accordance with the interrupt processing output signal when the reconstruction processor 15 receives the interrupt processing output signal from each of the interrupt processing units 20, 30 and 40.

The reconstruction processor 15 is designed to reconstruct the encoded information to be transmitted to each of the communication terminals 1A to 1N and the like in accordance with the control parameter. The process of the reconstruction performed by the reconstruction processor 15 will be described in detail below. The reconstruction processor 15 first refers to the control parameter set in the control parameter storage section 15a provided in the reconstruction processor 15. The reconstruction processor 15 then extracts encoded information corresponding to a necessary number of the layers from encoded information transmitted from the communication terminals 1A to 1N. However, when the transmission bit rate included in the control parameter and set for each of the communication terminals 1A to 1N is larger than a transmission bit rate indicated by the terminal transmission mode information included in the received encoded information, the reconstruction processor 15 extracts encoded information or encoded information corresponding to the number of the layers in accordance with the transmission bit rate of the received encoded information.

The present embodiment will be described taking an example in which the number of the layers is 4, and transmission bit rates are expressed by BR1, BR2, BR3 and BR4 in the order from the lowest transmission bit rate. When a transmission bit rate set for the communication terminal 1A is BR2, and a transmission bit rate indicated by the terminal transmission mode information in the received encoded information received from the communication terminal 1A is BR3, the reconstruction processor 15 selects and extracts the encoded information (hereinafter referred to as a “base layer encoded information”) in the base layer and the encoded information (hereinafter referred to as a “first enhancement layer encoded information”) in the first enhancement layer in order to support the lower transmission bit rate.

On the other hand, when the transmission bit rate set for the communication terminal 1A is BR3, and the transmission bit rate indicated by the terminal transmission mode information in the received encoded information received from the communication terminal 1A is BR2, the reconstruction processor 15 selects and extracts the base layer encoded information and the first enhancement layer encoded information in order to support the lower transmission bit rate.

The reconstruction processor 15 extracts the encoded information of each of the layers from the received encoded information transmitted from each of the communication terminals 1A to 1N to reconstruct the extracted encoded information and the control information. The reconstruction processor 15 then outputs, to the encoded information integrator 16a, information obtained by reconstructing the extracted encoded information and the control information. More specifically, encoded information to be transmitted to the communication terminal participating in the multi-party communications, for example, the communication terminal 1A, is deemed as encoded information of each of the layers, which is extracted by using the above-described process from the encoded information output from the communication terminals 1B to 1N obtained by excluding the communication terminal 1A from all the communication terminals 1A to 1N. The control information to be transmitted to each of the communication terminals 1A to 1N is composed of relay device transmission mode information and encoded information configuration information, which are described below.

The relay device transmission mode information is designed to indicate a transmission bit rate of a signal to be transmitted to each of the communication terminals 1A to 1N. The transmission bit rate is selected from a plurality of predefined transmission bit rates. In the present embodiment, the relay device transmission mode information is designed to indicate any of four types of the transmission bit rates BR1, BR2, BR3 and BR4 (BR1<BR2<BR3<BR4).

The encoded information configuration information is designed to indicate which one of the communication terminals 1A to 1N transmits the source and which type of the encoded information is. For example, when the encoded information to be transmitted to the communication terminal 1A is composed of the base layer encoded information and the first enhancement layer encoded information, which are received from the communication terminal 1B, and of the second enhancement layer encoded information and the third enhancement layer encoded information, which are received from the communication terminal 1C, the encoded information configuration information indicates “B:L2 (base, enh1), C:L2 (enh2, enh3)”. The characters B and C in the encoded information configuration information indicate an ID of the communication terminal 1A and an ID of the communication terminal 1B, respectively. The symbol L2 placed at the back of each of the IDs of the communication terminals indicates the number (hereinafter referred to as the “number of occupation layers) of the layers each occupied by encoded information obtained by reconstructing a signal received from each of the communication terminals having the IDs. When the number of the occupation layers is 1, a symbol L1 is expressed. When the number of the occupation layers is 3, a symbol L3 is expressed. The characters in the brackets indicate the layers including encoded information to be transmitted. The symbols, base, enh1, enh2, enh3 indicate the base layer encoded information, the first enhancement layer encoded information, the second enhancement layer encoded information, and the third enhancement layer encoded information, respectively.

The reconstruction processor 15 is designed to update the control parameter when the reconstruction processor 15 receives the interrupt processing output signal from any one of the first interrupt pattern processing unit 20, the second interrupt pattern processing unit 30 and the third interrupt pattern processing unit 40. The process for updating the control parameter will be described below.

When the first interrupt pattern processing unit 20, the second interrupt pattern processing unit 30 or the third interrupt pattern processing unit 40 receives an interrupt signal, the first interrupt pattern processing unit 20, the second interrupt pattern processing unit 30 or the third interrupt pattern processing unit 40, which receives the interrupt signal, outputs the interrupt processing output signal including information (hereinafter referred to as “terminal group information”) indicative of a communication terminal participating in the multi-party communications. The terminal group information is designed to indicate a communication terminal participating in the multi-party communications at the time of the generation of the interrupt processing output signal. The reconstruction processor 15 determines, in accordance with the obtained terminal group information, how to assign encoded information received from each of the communication terminals to any of the layers of encoded information to be transmitted to each of the communication terminals. The interrupt processing output signal may include the interrupt signal input to any of the first, second and third interrupt pattern processing unit 20, 30 and 40. The reconstruction processor 15 maintains the control parameter currently set when the reconstruction processor 15 receives the interrupt signal from any of the first, second and third interrupt pattern processing unit 20, 30 and 40.

Specifically, when the communication terminals 1A, 1B, 1C perform the multi-party communications in the case where the number of the layers is 4 in the scalable communications, the reconstruction processor 15 determines how to assign encoded information transmitted from two of the communication terminals 1A, 1B, 1C to the four layers in the other one of the communication terminals 1A, 1B, 1C. The encoded information transmitted from the two of the communication terminals 1A, 1B, and 1C may be assigned to two of the layers in the other one of the communication terminals 1A, 1B, 1C. In this case, the control parameter is updated to the one indicating “A:L2, B:L2, C:L2.” The encoded information transmitted from the two of the communication terminals 1A, 1B, and 1C may also be unevenly assigned to two or more of the layers in accordance with the level of a speech/audio signal to be reproduced based on the encoded information transmitted from each of the communication terminals and with information on communication conditions including the statuses of lines used to communicate with the communication terminals. The reconstruction processor 15 determines how to assign encoded information to be transmitted to each of the communication terminals and then updates the control parameter to indicate the number of the layers assigned to the communication terminals.

The encoded information integrator 16a receives the encoded information and the control information, which are reconstructed by and output from the reconstruction processor 15. The encoded information integrator 16a then integrates the encoded information and the control information for each of the communication terminals 1A to 1N and the like to output, to the transmitter 16b, the encoded information and the control information, which are integrated.

The transmitter 16b transmits, to each of the communication terminals 1A to 1N and the like, the encoded information and the control information, which are integrated for each of the communication terminals 1A to 1N and the like and output from the encoded information integrator 16a.

The communication processor 19 is designed to connect and disconnect a line in accordance with a signal output from any of the first, second, third interrupt pattern processing units 20, 30, and 40. In FIG. 2, an arrow shown by a solid line indicates the direction of a signal flow, and an arrow shown by a dashed line indicates the direction of control.

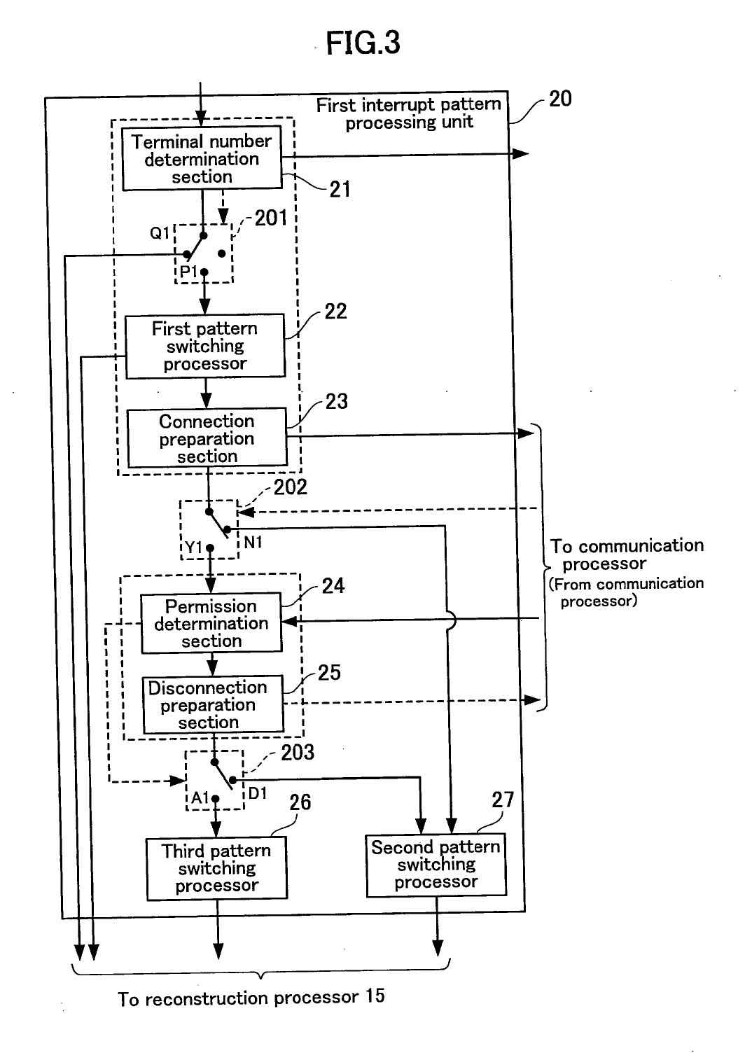

FIG. 3 is a block diagram showing the configuration of the first interrupt pattern processing unit 20 according to the first embodiment. The first interrupt pattern processing unit 20 has a terminal number determination section 21, a first pattern switching processor 22, a connection preparation section 23, a permission determination section 24, a disconnection preparation section 25, a third pattern switching processor 26, a second pattern switching processor 27, and control switches 201 to 203.

The terminal number determination section 21 receives the first pattern interrupt signal from the interrupt determination 12. The terminal number determination section 21 then determines whether or not the number of communication terminals currently participating in the multi-party communications is smaller than the maximum number (hereinafter referred to as the “maximum terminal number) of communication terminals capable of participating in the multi-party communications. When the terminal number determination section 21 determines that the number of communication terminals currently participating in the multi-party communications is smaller than the maximum terminal number, the control switch 201 operates to connect the terminal number determination section 21 to a terminal P1 of the control switch 201. The terminal number determination section 21 then outputs, to the first pattern switching processor 22, the interrupt signal and data on the number of communication terminals participating in the multi-party communications. The maximum terminal number may be a predetermined number equal to or smaller than the number of layers in which a scalable coding technique is used. When the terminal number determination section 21 determines that the number of communication terminals currently participating in the multi-party communications is not smaller than the maximum terminal number, the control switch 201 operates to connect the terminal number determination section 21 to a terminal Q1 of the control switch 201. The terminal number determination section 21 then outputs, to the reconstruction processor 15, the interrupt signal and data on the number of communication terminals participating in the multi-party communications.

The first pattern switching processor 22 receives the interrupt signal and the data on the number of communication terminals participating in the multi-party communications, which is output by the terminal number determination section 21, when the control switch 201 operates to connect the terminal number determination section 21 to the terminal P1. The first pattern switching processor 22 then outputs terminal group information on the communication terminals 1B to 1N obtained by excluding a communication terminal (hereinafter, regarded as the communication terminal 1A), which transmits a participation request signal designed to cause the communication terminal 1A to 1N to participate in the multi-party communications and included in the first pattern interrupt signal, from all the communication terminals 1A to 1N participating in the multi-party communications. The first pattern switching processor 22 is designed to output the first pattern interrupt signal to the communication preparation section 23 when the terminal number determination section 21 is in connection with the terminal P1 of the control switch 201. The first pattern switching processor 22 does not operate when the terminal number determination section 21 is in connection with the terminal Q1 of the control switch 201.

The connection preparation section 23 receives the first pattern interrupt signal from the first pattern switching processor 22. The connection preparation section 23 outputs, to the communication processor 19, information indicative of the communication terminal 1A that transmits the participation request signal and of the communication terminal 1Z that is to participate in the multi-party communications, and included in the first pattern interrupt signal. The connection preparation section 23 outputs the first pattern interrupt signal to the control switch 202.

The communication processor 19 shown in FIG. 2 receives the information output from the connection preparation section 23 shown in FIG. 3. The communication processor 19 then connects the communication terminal 1A with the communication terminal 1N by use of a line other than the line used for the multi-party communications. The communication processor 19 controls the control switch 202 to connect the connection preparation section 23 to a terminal Y1 of the control switch 202 when the connection between the communication terminals 1A and 1Z is established. The communication processor 19 controls the control switch 202 to connect the connection preparation section 23 to a terminal N1 of the control switch 202 when the connection between the communication terminals 1A and 1Z is not established. When the communication processor 19 receives a participation acceptance/denial signal indicating whether or not to participate in the multi-party communications from the communication terminal 1Z during communications between the communication terminals 1A and 1Z through the line other than the line used for the multi-party communications, the communication processor 19 outputs the participation acceptance/denial signal to the permission determination section 24. Hereinafter, a signal indicating participation in multi-party communications is referred to as a “participation acceptance signal” while a signal indicating denial of participation in multi-party communications is referred to as a “participation denial signal.” When the communication processor 19 outputs the participation acceptance/denial signal to the permission determination section 24, the communication processor 19 executes processing for disconnecting (terminating) the communications performed through the line other than the line used for the multi-party communications.

The permission determination section 24 is designed to receive the first pattern interrupt signal transmitted from the connection preparation section 23 and the participation acceptance/denial signal output from the communication processor 19 when the connection preparation section 23 is in connection with the terminal Y1 of the control switch 202. The permission determination section 24 controls the control switch 203 to connect the disconnection preparation section 25 to the terminal A1 and outputs the first pattern interrupt signal to the disconnection preparation section 25 when the participation acceptance/denial signal output from the communication processor 19 indicates a participation acceptance signal. The permission determination section 24 controls the control switch 203 to connect the disconnection preparation section 25 to the terminal D1 and outputs the first pattern interrupt signal to the disconnection preparation section 25 when the participation acceptance/denial signal output from the communication processor 19 indicates a participation denial signal. The permission determination section 24 does not operate when the connection preparation section 23 is in connection with the terminal 1N of the control switch 202.

The second pattern switching processor 27 receives the first pattern interrupt signal output from the connection preparation section 23 when the connection preparation section 23 is in connection with the terminal 1N of the control switch 202. The second pattern switching processor 27 then outputs, to the reconstruction processor 15, terminal group information on the communication terminals 1A to 1N, which is obtained by adding information on the communication terminal 1A to the terminal group information on the communication terminals 1B to 1N. In this case, the information on the communication terminal 1A is configured to be included in the first pattern interrupt signal transmitted from the communication terminal 1A. The second pattern switching processor 27 does not operate when the connection preparation section 23 is in connection with the terminal 1N of the control switch 202 and the disconnection preparation section 25 is in connection with the terminal D1 of the control switch 203.

The disconnection preparation section 25 receives the first pattern interrupt signal output from the permission determination section 24. The disconnection preparation section 25 then outputs the first pattern interrupt signal to the second pattern switching processor 27 when the disconnection preparation section 25 is in connection with the terminal D1 of the control switch 203. The disconnection preparation section 25 outputs, to the third pattern switching processor 26, the first pattern interrupt signal received from the permission determination section 24 when the disconnection preparation section 25 is in connection with the terminal A1 of the control switch 203. The disconnection preparation section 25 controls the communication processor 19 to cause the communication processor 19 to execute processing for disconnecting (terminating) the communications performed through the line other than the line used for the multi-party communications.

The third pattern switching processor 26 receives the first pattern interrupt signal output from the disconnection preparation section 25 when the disconnection preparation section 25 is in connection with the terminal A1 of the control switch 203. The third pattern switching processor 26 then outputs, to the reconstruction processor 15, terminal group information on the communication terminals 1A to 1N and 1Z, obtained by adding the information on the communication terminal 1A and information on the communication terminal 1Z to the terminal group information on the communication terminals 1B to 1N. In this case, the information on the communication terminal 1A is included in the first pattern interrupt signal transmitted from the communication terminal 1A. The third pattern switching processor 26 does not operate when the disconnection preparation section 25 is in connection with the terminal D1 of the control switch 203.

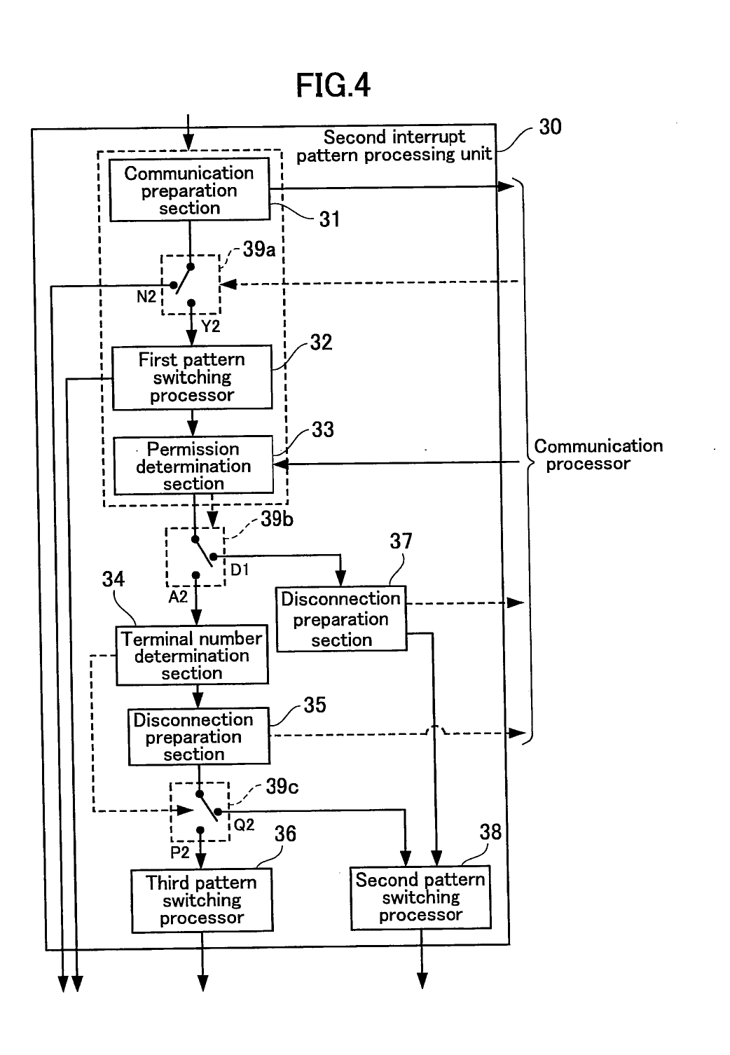

FIG. 4 is a block diagram showing the second pattern processing unit 30 according to the present embodiment. The second pattern processing unit 30 has a connection preparation section 31, a first pattern switching processor 32, a permission determination 33, a terminal number determination section 34, disconnection preparation sections 35 and 37, a third pattern switching processor 36, a second pattern switching processor 38, and control switches 39a to 39c.

The connection preparation section 31 receives the second pattern interrupt signal output from the interrupt determination section 12. The connection preparation section 31 then outputs information on the communication terminal 1Z and on the communication terminal 1A which is in multi-party communications and to which the communication terminal 1Z transmits a line connection request signal to attempt to connect. In this case, the information is included in the second pattern interrupt signal. The connection preparation section 31 outputs the second pattern interrupt signal to the control switch 39a.

The communication processor 19 shown in FIG. 2 receives the information on the communication terminals 1A and 1Z from the connection preparation section 31 shown in FIG. 4. The communication processor 19 then connects the communication terminal 1A with the communication terminal 1Z by use of a line other than the line used for the multi-party communications. The communication processor 19 controls the control switch 39a to connect the connection preparation section 31 to a terminal Y2 of the control switch 39a when the connection between the communication terminals 1A and 1Z is established. The communication processor 19 controls the control switch 39a to connect the connection preparation section 31 to a terminal N2 of the control switch 39a when the connection between the communication terminals 1A and 1Z is not established.

When the communication processor 19 shown in FIG. 2 receives a participation acceptance signal or a participation denial signal from the communication terminal 1A during communications between the communication terminals 1A and 1Z through the line other than the line used for the multi-party communications, the communication processor 19 outputs the participation acceptance signal or participation denial signal to the permission determination section 33. When the communication processor 19 outputs the participation acceptance signal or participation denial signal to the permission determination section 33, the disconnection preparation section 35 or 37 controls the communication processor 19 to cause the communication processor 19 to execute processing for disconnecting (terminating) the communications performed through the line other than the line used for the multi-party communications. It should be noted that the communication processor 19 executes the processing for disconnecting (terminating) the communications performed through the line other than the line used for the multi-party communications when the communication processor 19 receives a disconnection request signal from the communication terminal 1A or 1Z.

The first pattern switching processor 32 shown in FIG. 3 receives the second pattern interrupt signal output from the connection preparation section 31 when the connection preparation section 31 is in connection with the terminal Y2 of the control switch 39a. The first pattern switching processor 32 outputs terminal group information on the communication terminals 1B to 1N obtained by removing information on the communication terminal 1A from the terminal group information on the communication terminals 1A to 1N. In this case, the information on the communication terminal 1A is included in the second pattern interrupt signal. The first pattern switching processor 32 outputs the second pattern interrupt signal to the permission determination section 33 when the connection preparation section 31 is in connection with the terminal Y2 of the control switch 39a. The first pattern switching processor 32 does not operate when the connection preparation section 31 is in connection with the terminal N2 of the control switch 39a.

The permission determination section 33 receives the second pattern interrupt signal output from the first pattern switching processor 32 and the participation acceptance signal or participation denial signal output from the communication processor 19. When the permission determination section 33 receives the participation acceptance signal output from the communication processor 19, the permission determination section 33 controls the control switch 39a to connect the permission determination section 33 to the terminal A2 to output the second pattern interrupt signal to the terminal number determination section 34. When the permission determination section 33 receives the participation denial signal output from the communication processor 19, the permission determination section 33 controls the control switch 39a to connect the permission determination section 33 to the terminal D2 to output the second pattern interrupt signal to the disconnection preparation section 37.

The terminal number determination section 34 receives the second pattern interrupt signal output from the permission determination section 33 when the permission determination section 33 is in connection with a terminal A2 of the control switch 39b. The terminal number determination section 34 compares the number of communication terminals currently participating in the multi-party communications with the maximum number (maximum terminal number) of terminals capable of participating in the multi-party communications. When the number of the communication terminals currently participating in the multi-party communications is smaller than the maximum terminal number, the terminal number determination section 34 controls the control switch 39c to connect the disconnection preparation section 35 to a terminal P2 of the control switch 39c to output the second pattern interrupt signal to the disconnection preparation section 35. The maximum terminal number may be a predetermined number equal to or less than the number of layers in which a scalable coding technique is used. When the number of the communication terminals currently participating in the multi-party communications is not smaller than the maximum terminal number, the terminal number determination section 34 controls the control switch 39c to connect the disconnection preparation section 35 to a terminal Q2 of the control switch 39c to output the second pattern interrupt signal to the disconnection preparation section 35.

The disconnection preparation section 37 receives the second pattern interrupt signal output from the permission determination section 33 when the permission determination section 33 is in connection with the terminal D2 of the control switch 39b. The disconnection preparation section 37 then outputs the received second pattern interrupt signal to the second pattern switching processor 38. The disconnection preparation section 37 controls the communication processor 19 to cause the communication processor 19 to execute processing for disconnecting (terminating) the communications performed through the line other than the line used for the multi-party communications when the control switch 39b is in connection with the terminal D2. The disconnection preparation section 37 is designed not to operate when the control switch 39b is in connection with the terminal A2.

The disconnection preparation section 35 receives the second pattern interrupt signal output from the terminal number determination section 34. The disconnection preparation section 35 outputs the received second pattern interrupt signal to the second pattern switching processor 38 when the disconnection preparation section 35 is in connection with the terminal Q2 of the control switch 39c. When the disconnection preparation section 35 is in connection with the terminal P2 of the control switch 39c, the disconnection preparation section 35 outputs the received second pattern interrupt signal to the third pattern switching processor 36. The disconnection preparation section 35 controls the communication processor 19 to cause the communication processor 19 to execute processing for disconnecting (terminating) the communications performed through the line other than the line used for the multi-party communications.

The second pattern switching processor 38 receives the second pattern interrupt signal output from the disconnection preparation section 37 when the permission determination section 33 is in connection with the terminal D2 of the control switch 39b. The second pattern switching processor 38 then outputs terminal group information on the communication terminals 1A to 1N to the reconstruction processor 15. In this case, the terminal group information is obtained by adding the information on the communication terminal 1A to the terminal group information on the communication terminals 1B to 1N, and the information on the communication terminal 1A is included in the second pattern interrupt signal transmitted from the communication terminal 1Z participating in the multi-party communications. The second pattern switching processor 38 receives the second pattern interrupt signal output from the disconnection preparation section 35 when the disconnection preparation section 35 is in connection with the terminal Q2 of the control switch 39c. The second pattern switching processor 38 then outputs the terminal group information on the communication terminals 1A to 1N to the reconstruction processor 15. In this case, the terminal group information on the communication terminals 1A to 1N is obtained by adding the information on the communication terminal 1A to the terminal group information on the communication terminals 1B to 1N, the information on the communication terminal 1A is included in the first pattern interrupt signal transmitted from the communication terminal 1A. The second pattern switching processor 38 does not operate when the permission determination section 33 is in connection with the terminal D2 of the control switch 39b and the disconnection preparation section 35 is in connection with the terminal Q2 of the control switch 39c.

The third pattern switching processor 36 receives the second pattern interrupt signal output from the disconnection preparation section 35 when the disconnection preparation section 35 is in connection with the terminal P2 of the control switch 39c. The third pattern switching processor 36 then outputs the terminal group information on the communication terminals 1A to 1N and 1Z to the reconstruction processor 15. In this case, the terminal group information is obtained by adding the information on the communication terminal 1A included in the second pattern interrupt signal and the information on the communication terminal 1Z to the terminal group information 1B to 1N. The third pattern switching processor 36 does not operate when the permission determination section 33 is in connection with the terminal D2 of the control switch 39b.

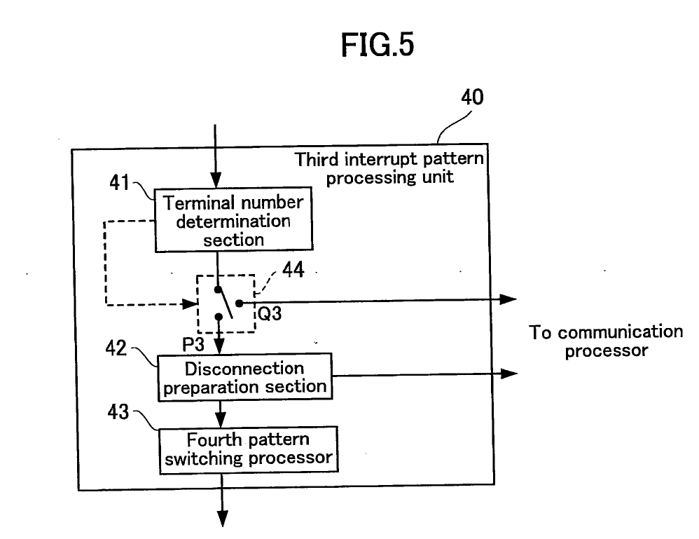

FIG. 5 is a block diagram showing the configuration of the third interrupt pattern processing unit 40 according to the present embodiment. The third interrupt pattern processing unit 40 has a terminal number determination section 41, a disconnection preparation section 42, a fourth pattern switching processor 43, and a control switch 44.

The terminal number determination section 41 receives the third pattern interrupt signal output from the interrupt determination section 12. The terminal number determination section 41 determines whether or not the number of communication terminals participating in the multi-party communications is equal to or less than 2. When the terminal number determination section 41 determines that the number of communication terminals participating in the multi-party communications is equal to or more than 3, the terminal number determination section 41 controls the control switch 44 to connect the terminal number determination section 41 to a terminal P3 of the control switch 44 to output the third pattern interrupt signal to the disconnection preparation section 42. When the terminal number determination section 41 determines that the number of communication terminals participating in the multi-party communications is equal to or less than 2, the terminal number determination section 41 controls the control switch 44 to connect the terminal number determination section 41 to a terminal Q3 of the control switch 44 to output the third pattern interrupt signal to the communication processor 19.

The disconnection preparation section 42 receives the third pattern interrupt signal when the terminal number determination section 41 determines that the number of communication terminals participating in the multi-party communications is equal to or more than 3. The disconnection preparation section 42 then transmits the received third pattern interrupt signal to the communication processor 19 and requests to disconnect the communication terminal 1N specified in the third pattern interrupt signal. The disconnection preparation section 42 also outputs the received third pattern interrupt signal to the fourth pattern switching processor 43. When the terminal number determination section 41 determines that the number of communication terminals participating in the multi-party communications is equal to or less than 2, the disconnection preparation section 42 does not perform the above-described operations.

The fourth pattern switching processor 43 outputs terminal group information on the communication terminals 1A to 1M to the reconstruction processor 15 when the fourth pattern switching processor 43 receives the third pattern interrupt signal from the disconnection preparation section 42. In this case, the terminal group information is obtained by removing the information on the communication terminal 1N from the terminal group information on the communication terminals 1A to 1N. When the terminal number determination section 41 determines that the number of communication terminals participating in the multi-party communications is equal to or less than 2, the fourth pattern switching processor 43 does not perform the above-described operations.

The communication processor 19 shown in FIG. 2 executes processing for terminating the multi-party communications when the communication processor 19 receives the third pattern interrupt signal output from the terminal number determination 41 shown in FIG. 5. The processing for terminating the multi-party communications is not described since the processing is executed similarly to processing for terminating two-way communications.

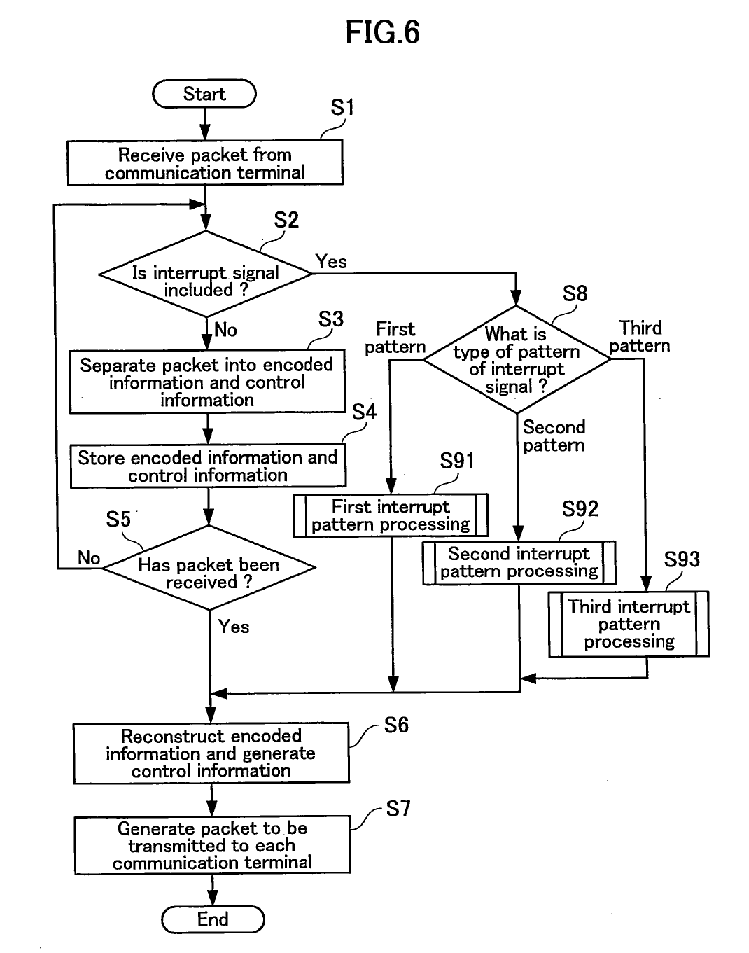

FIG. 6 is a flowchart showing a process of operations of the relay device 10 according to the present embodiment. The operations of the relay device 10 are controlled by a CPU constituting a controller (not shown) of the relay device 10.

The receiver 11 of the relay device 10 receives a signal transmitted as a packet from each of the communication terminals 1A to 1N and the like outputs the received signal to the interrupt determination section 12 in step S1.

The interrupt determination section 12 determines whether or not the signal received from each of the communication terminals 1A to 1N in step S1 includes an interrupt signal for connecting or disconnecting a corresponding communication terminal to increase or decrease the number of the communication terminals participating in the multi-party communications in step S2. When the interrupt determination section 12 determines that the signal received from each of the communication terminals 1A to 1N includes the interrupt signal, the process proceeds to step S8. When the interrupt determination section 12 determines that the signal received from each of the communication terminals 1A to 1N does not include the interrupt signal, the interrupt determination section 12 outputs encoded information to the encoded information separator 13, and the process proceeds to step S3. However, even when the interrupt determination section 12 determines that the received signal from each of the communication terminals 1A to 1N includes the interrupt signal in step S2, the process on a signal not including an interrupt signal proceeds to step S3.

The encoded information separator 13 of the relay device 10 receives a signal including the encoded information output from the interrupt determination section 12 when the interrupt determination section 12 determines that the signal received from each of the communication terminals 1A to 1N does not include the interrupt signal in step S2. The encoded information separator 13 sequentially separates the received encoded information into encoded information component and a control information component. The encoded information separator 13 then outputs the encoded information component and the control information component to the encoded information managing section 14 in step S3.

The encoded information managing section 14 sequentially accumulates the encoded information component and the control information component until the encoded information managing section 14 obtains encoded information and control information in step S4.

The encoded information managing section 14 of the relay device 10 determines whether or not the encoded information managing section 14 obtains the encoded information and the control information in step S5 as a result of the sequential accumulation of the encoded information component and the control information component in step S4. When the encoded information managing section 14 determines that the encoded information managing section 14 does not obtain the encoded information and the control information, steps S2 to S5 are repeated. When the encoded information managing section 14 determines that the encoded information managing section 14 obtains the encoded information and the control information, the process proceeds to step S6.

When the encoded information managing section 14 determines that the signal received from each of the communication terminals 1A to 1N includes the interrupt signal, the interrupt determination section 12 of the relay device 10 determines the type of the pattern of the interrupt signal. The interrupt determination section 12 then outputs the interrupt signal to the first interrupt pattern processing unit 20, the second interrupt pattern processing unit 30, or the third interrupt pattern processing unit 40 in accordance with the type of the pattern of the interrupt signal in step S8.

When the interrupt determination section 12 determines that the interrupt signal has the first pattern, the interrupt determination section 12 outputs the first pattern interrupt signal to the first interrupt pattern processing unit 20. The first interrupt pattern processing unit 20 then executes first interrupt pattern processing described later. The first interrupt pattern processing unit 20 outputs an interrupt processing output signal obtained by the first interrupt pattern processing to the reconstruction processor 15 in step S91.

When the interrupt determination section 12 determines that the interrupt signal has the second pattern, the interrupt determination section 12 outputs the second pattern interrupt signal to the second interrupt pattern processing unit 30. The second interrupt pattern processing unit 30 then executes second interrupt pattern processing described later. The second interrupt pattern processing unit 30 outputs an interrupt processing output signal obtained by the second interrupt pattern processing to the reconstruction processor 15 in step S92.

When the interrupt determination section 12 determines that the interrupt signal has the third pattern, the interrupt determination section 12 outputs the third pattern interrupt signal to the third interrupt pattern processing unit 40. The third interrupt pattern processing unit 40 then executes third interrupt pattern processing described later. The third interrupt pattern processing unit 40 outputs an interrupt processing output signal obtained by the third interrupt pattern processing to the reconstruction processor 15 in step S93.

When the encoded information managing section 14 determines that the encoded information managing section 14 obtains the encoded information and the control information, the reconstruction processor 15 reconstructs the encoded information to be transmitted to each of the communication terminals 1A to 1N and the like and generates control information to output the reconstructed encoded information and the generated control information to the encoded information integrator 16a in step S6.

When the encoded information integrator 16a receives the reconstructed encoded information and the generated control information in step S6, the encoded information integrator 16a outputs the reconstructed encoded information and the generated control information to the transmitter 16b. The transmitter 16b then transmits the reconstructed encoded information and the generated control information to each of the communication terminals 1A to 1N in step S7.

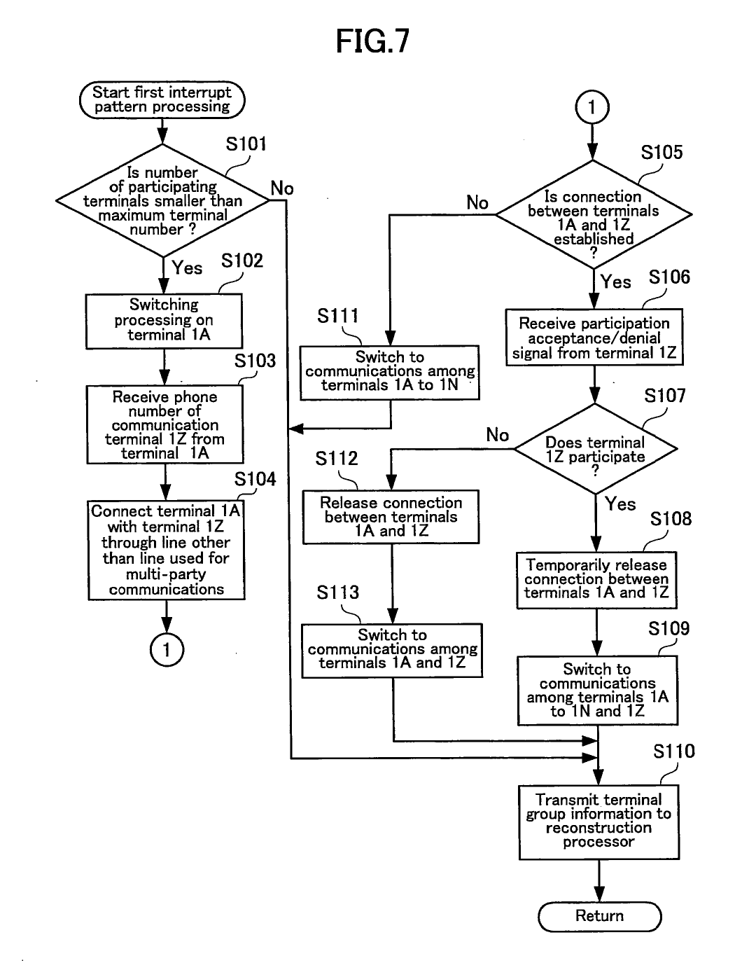

FIG. 7 is a flowchart showing a process for the first interrupt pattern processing according to the present embodiment. The CPU (not shown) constituting the controller of the relay device 10 controls operations of the first interrupt pattern processing unit 20. The operations are described below.

The terminal number determination section 21 of the first pattern processing unit 20 determines whether or not the number of communication terminals currently participating in the multi-party communications among the communication terminals 1A to 1N is smaller than the maximum number (maximum terminal number) of communication terminals capable of participating in the multi-party communications in step S101. When the terminal number determination section 21 determines that the number of the communications terminals currently participating in the multi-party communications is smaller than the maximum terminal number, the process proceeds to step S102. When the terminal number determination section 21 determines that the number of the communications terminals currently participating in the multi-party communications is not smaller than the maximum terminal number, the process proceeds to step S110.

When the terminal number determination section 21 determines that the number of the communications terminals currently participating in the multi-party communications is smaller than the maximum terminal number, the communication processor 19 temporarily disconnects the communication terminal 1A from a line (hereinafter referred to as a “multi-party communication line”) used for the multi-party communications, and the terminal number determination section 21 generates terminal group information on the communication terminals 1B to 1N and outputs the generated terminal group information to the reconstruction processor 15 in step S102.

When the communication processor 19 temporarily disconnects the communication terminal 1A from the multi-party communication line, the communication processor 19 receives, from the communication terminal 1A, a signal indicating a phone number of the communication terminal 1Z that is to participate in the multi-party communications in step S103.

When the communication processor 19 receives the signal indicating the phone number of the communication terminal 1Z from the communication terminal 1A, the communication processor 19 connects the communication terminal 1A with the communication terminal 1Z through a line other than the line used for the multi-party communications in step S104.

When the communication processor 19 connects the communication terminal 1A with the communication terminal 1Z in step S104, the communication processor 19 determines whether or not the connection between the communication terminals 1A and 1Z is established in step S105. When the communication processor 19 determines that the connection between the communication terminals 1A and 1Z is established, the process proceeds to step S106. When the communication processor 19 determines that the connection between the communication terminals 1A and 1Z is not established, the process proceeds to step S111.

When the communication processor 19 determines that the connection between the communication terminals 1A and 1Z is established, the communication processor 19 receives a participation acceptance/denial signal from the communication terminal 1Z in step S106.

When the communication processor 19 receives the participation acceptance/denial signal from the communication terminal 1Z in step S106, the permission determination section 24 determines whether or not the received participation acceptance/denial signal is a participation acceptance signal in step S107. When the permission determination section 24 determines that the received participation acceptance/denial signal is a participation acceptance signal, the process proceeds to step S108. When the permission determination section 24 determines that the received participation acceptance/denial signal is a participation denial signal, the process proceeds to step S112.

When the permission determination section 24 determines that the received participation acceptance/denial signal is a participation acceptance signal in step S107, the communication processor 19 temporarily releases the connection between the communication terminals 1A and 1Z in step S108.

The communication processor 19 connects the communication terminals 1A and 1Z to the multi-party communication line to cause the communication terminals 1A and 1Z to participate in the multi-party communications when the connection between the communication terminals 1A and 1Z is temporarily released in step S108.

When the communication processor 19 determines that the connection between the communication terminals 1A and 1Z is not established in step S105, the communication processor 19 connects the communication terminal 1A to the multi-party communication line to allow the communication terminals 1A to 1N to perform the multi-party communications in step S111.

When the permission determination section 24 determines that the received participation acceptance/denial signal is a participation denial signal in step S107, the communication processor 19 releases the connection between the communication terminals 1A and 1Z in step S112.

When the communication processor 19 releases the connection between the communication terminals 1A and 1Z in step S112, the communication processor 19 connects the communication terminal 1A to the multi-party communication line to allow the communication terminals 1A to 1N to perform the multi-party communications in step S113.

When the terminal number determination section 21 determines that the number of communications terminals currently participating in the multi-party communications among the communication terminals 1A to 1N is not smaller than the maximum terminal number in step S101, or when the communication processor 19 connects the communication terminals 1A and 1Z to the multi-party communication line in step S109, or when the communication processor 19 connects the communication terminal 1A to the multi-party communication line in step S111, or when the communication processor 19 connects the communication terminal 1A to the multi-party communication line in step S113, the first pattern interrupt processing unit 10 outputs an interrupt processing output signal such as terminal group information to the reconstruction processor 15 in step S110.

The interrupt processing output signal generated in step S110 is the first pattern interrupt signal when the terminal number determination section 21 determines that the number of the communications terminals participating in the multi-party communications is smaller than the maximum terminal number in step S101. The interrupt processing output signal generated in step S110 is the terminal group information on the communication terminals 1A to 1N and 1Z when the communication terminals 1A and 1Z are connected to the multi-party communication line in step S109. The interrupt processing output signal generated in step S110 is the terminal group information on the communication terminals 1A to 1N when the communication terminal 1A is connected to the multi-party communication line in step S111 and when the communication terminal 1A is connected to the multi-party communication line in step S113.

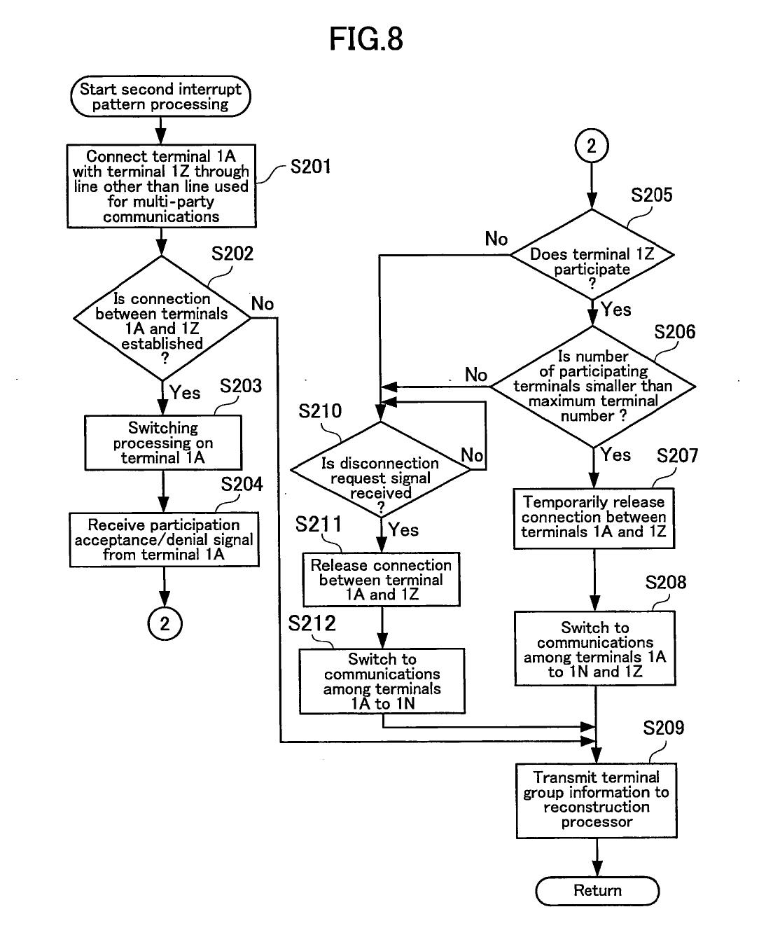

FIG. 8 is a flowchart showing a process for the second interrupt pattern processing according to the present embodiment. The CPU (not shown) constituting the controller of the relay device 10 controls operations of the second interrupt pattern processing unit 30. The operations are described below.

The connection preparation section 31 of the second interrupt pattern processing unit 30 outputs the second pattern interrupt signal to the communication processor 19 when the connection preparation section 31 receives the second pattern interrupt signal. The communication processor 19 executes connection processing for connecting the communication terminal 1Z that transmits the second pattern interrupt signal with a communication terminal (hereinafter regarded as the “communication terminal 1A) to be connected to the communication terminal 1Z through a line other than the line used for multi-party communications in step S201.

When the communication processor 19 executes the connection processing, the communication processor 19 determines whether or not the connection between the communication terminals 1A and 1Z is established in step S202. When the communication processor 19 determines that the connection between the communication terminals 1A and 1Z is established, the process proceeds to step S203. When the communication processor 19 determines that the connection between the communication terminals 1A and 1Z is not established, the process proceeds to step S209.

When the communication processor 19 determines that the connection between the communication terminals 1A and 1Z is established in step S202, the communication processor 19 temporarily disconnects the communication terminal 1A from a line (hereinafter referred to as a multi-party communication line) used for the multi-party communications and generates terminal group information on the communication terminals 1B to 1N to output the generated terminal group information to the reconstruction processor 15 in step S203.

When the communication processor 19 temporarily disconnects the communication terminal 1A from the multi-party communication line in step S203, the communication processor 19 receives a participation acceptance/denial signal from the communication terminal 1A in step S204.

When the communication processor 19 receives the participation acceptance/denial signal from the communication terminal 1A in step S204, the permission determination section 33 determines whether or not the received participation acceptance/denial signal is a participation acceptance signal in step S205. When the permission determination section 33 determines that the received participation acceptance/denial signal is a participation acceptance signal, the process proceeds to step S206. When the permission determination section 33 determines that the received participation acceptance/denial signal is a participation denial signal, the process proceeds to step S210.

When the permission determination section 33 determines that the participation acceptance/denial signal received in step S205 is a participation acceptance signal, the terminal number determination section 34 determines whether or not the number of communication terminals participating in the multi-party communications is smaller than the maximum terminal number in step S206. When the terminal number determination section 34 determines that the number of communication terminals participating in the multi-party communications is smaller than the maximum terminal number, the process proceeds to step S207. When the terminal number determination section 34 determines that the number of communication terminals participating in the multi-party communications is not smaller than the maximum terminal number, the process proceeds to step S210.

When the terminal number determination section 34 determines that the number of communication terminals participating in the multi-party communications is smaller than the maximum terminal number in step S206, the communication processor 19 temporarily releases the connection between the communication terminals 1A and 1Z in step S207.

When the communication processor 19 temporarily releases the connection between the communication terminals 1A and 1Z in step S207, the communication processor 19 connects the communication terminals 1A and 1Z to the multi-party communication line to cause the communication terminals 1A and 1Z to participate in the multi-party communications in step S208.

When the permission determination section 33 determines that the participation acceptance/denial signal received in step S205 is a participation denial signal, the communication processor 19 waits for a disconnection request signal in step S210. When the communication processor 19 determines that the disconnection request signal is received, the process proceeds to step S211.

The communication processor 19 temporarily releases the connection between the communication terminals 1A and 1Z in step S211 when the communication processor 19 determines that the disconnection request signal is received in step S210.

When the communication processor 19 temporarily releases the connection between the communication terminals 1A and 1Z in step S211, the communication processor 19 connects the communication terminal 1A to the multi-party communication line to cause the communication terminal 1A to participate in the multi-party communications in step S212.

The communication processor 19 outputs an interrupt processing output signal such as terminal group information in S209 when the communication processor 19 determines that the connection between the communication terminals 1A and 1Z is not established in step S202, or when the communication processor 19 connects the communication terminals 1A and 1Z to the multi-party communication line in step S208, or when the communication processor 19 connects the communication terminal 1A to the multi-party communication line in step S212.

The interrupt processing output signal generated in step S209 is the second pattern interrupt signal when the communication processor 19 determines that the connection between the communication terminals 1A and 1Z is not established in step S202. The interrupt processing output signal generated in step S209 is the terminal group information on the communication terminals 1A to 1N and 1Z when the communication terminals 1A and 1Z are connected to the multi-party communication line in step S208. The interrupt processing output signal generated in step S209 is the terminal group information on the communication terminals 1A to 1N when the communication terminal 1A is connected to the multi-party communication line in step S212.

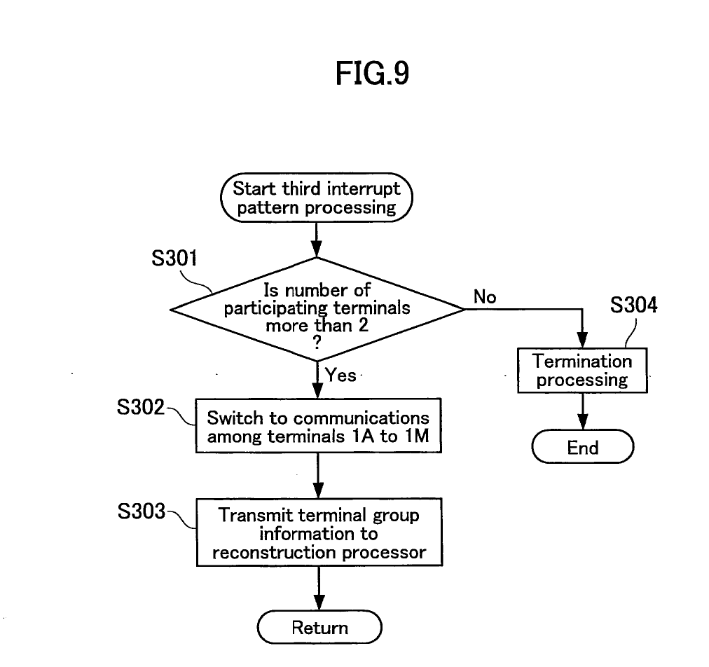

FIG. 9 is a flowchart showing a process for the third interrupt pattern processing according to the present embodiment. The CPU (not shown) constituting the controller of the relay device 10 controls operations of second interrupt pattern processing unit 30. The operations are described below.

The terminal determination section 41 of the third interrupt pattern processing section 40 receives the third pattern interrupt signal. When the terminal determination section 41 receives the third pattern interrupt signal, the terminal determination section 41 determines whether or not the number of communication terminals participating in the multi-party communications among the communication terminals 1A to 1N is more than 2 in step S301. The terminal determination section 41 determines that the number of communication terminals participating in the multi-party communications among the communication terminals 1A to 1N is more than 2, the process proceeds to step S302. The terminal determination section 41 determines that the number of communication terminals participating in the multi-party communications among the communication terminals 1A to 1N is less than 3, the process proceeds to step S304.

When terminal determination section 41 determines that the number of communication terminals participating in the multi-party communications among the communication terminals 1A to 1N is more than 2 in step S301, the communication processor 19 disconnects the communication terminal 1A, which transmits the third pattern interrupt signal, from the multi-party communication line, and switches the communications among the communication terminals 1A to 1N to the communications among the communication terminals 1A to 1M in step S302.

When the communication terminal 1N is disconnected from the multi-party communication line in step S302, the fourth pattern switching processor 43 outputs, to the reconstruction processor 15, terminal group information on the communication terminals 1A to 1M. In this case, the terminal group information is obtained by removing the information on the communication terminal 1A included in the third pattern interrupt signal from the terminal group information on the communication terminals 1A to 1N.

When terminal determination section 41 determines that the number of communication terminals participating in the multi-party communications among the communication terminals 1A to 1N is equal to or smaller than 2, the terminal number determination section 41 outputs the third pattern interrupt signal to the communication processor 19, and the communication processor 19 executes processing for terminating the multi-party communications in step S304.

The relay device 10 constructed as described above according to the present embodiment is designed to reconstruct received encoded information to transmit the reconstructed encoded information without decoding the encoded information. This decreases communication cost, reduces the number of communication lines used and suppresses an increase in cost necessary for the processing. The relay device 10 therefore makes it possible to achieve a multi-party communication system capable of preventing a decoded speech/audio signal from being significantly deteriorated.

The communication system has the relay device designed to transmit speech/audio and music signals by using a scalable coding technique, separate encoded information transmitted from each of a plurality of communication terminals into information encoded on a layer basis, reconstruct the separated encoded information and transmit the reconstructed encoded information to each of the communication terminals 1A to 1N and the like. The communication system thus constructed as described above makes it possible to achieve flexible multi-party communications. The relay device capable of reconstructing the encoded information on a layer basis makes it possible to achieve multi-party communications without substantial deterioration of the quality of a decoded signal as compared with a conventional technique in which a relay device decodes encoded information transmitted from a plurality of communication terminals, overlaps the decoded information, and encodes the decoded information.

The relay device according to the present embodiment is designed to generate control information used to combine the encoded information to be transmitted to the communication terminals in accordance with the control parameter including a transmission bit rate of a signal transmitted in the past. The relay device therefore makes it possible to reduce a load of the processing for detecting a transmission bit rate and generating control information.

The relay device according to the present embodiment is designed to set the control parameter in accordance with the level of a speech/audio signal reproduced and with communication conditions including the status of a line in the relay device according to the present embodiment. The relay device therefore makes it possible to achieve a layer configuration capable of reproduction of a sound comfortable on the side of a listener.

The relay device according to the present embodiment is designed to update the control parameter when the number of communication terminals participating in multi-party communications changes, thereby making it possible to reduce a load of the processing for generating control information.

The relay device according to the present embodiment is designed to select encoded information in accordance with the control information to combine the selected encoded information, thereby making it possible to reduce a load of the processing.

The relay device according to the present embodiment is designed to receive encoded information transmitted in the same time zone after receiving encoded information transmitted in the previous time zone, thereby making it possible to clarify the processing.

The relay device according to the present embodiment is designed to connect two communication terminals relating to an interrupt by use of a communication line other than the line used for multi-party communications. The relay device is therefore capable of performing the processing relating to the interrupt without a suspension of the multi-party communications.

The relay device according to the present embodiment is designed to connect two communication terminals relating to an interrupt by use of a communication line other than the line used for multi-party communications. The relay device is therefore capable of performing the processing relating to the interrupt without a suspension of the multi-party communications.

The method for processing a signal, according to the present embodiment, comprises the step of reconstructing received encoded information to transmit the reconstructed encoded information without decoding the encoded information. This suppresses an increase in cost necessary for the processing. The relay device therefore makes it possible to achieve a multi-party communication system capable of preventing a decoded speech/audio signal from being significantly deteriorated.

The operations of the relay device performing the signal processing for the multi-party communications are described above in the present embodiment. The present invention may be applied to the operations performed by a program for processing a signal, which causes a computer to execute the signal processing. The present invention may be also applied to the operations performed by using the program for processing a signal, which is written in a machine-readable storage medium such as a memory, disk, tape, CD, and DVD, thereby obtaining a similar effect to the present embodiment.

### Second Embodiment

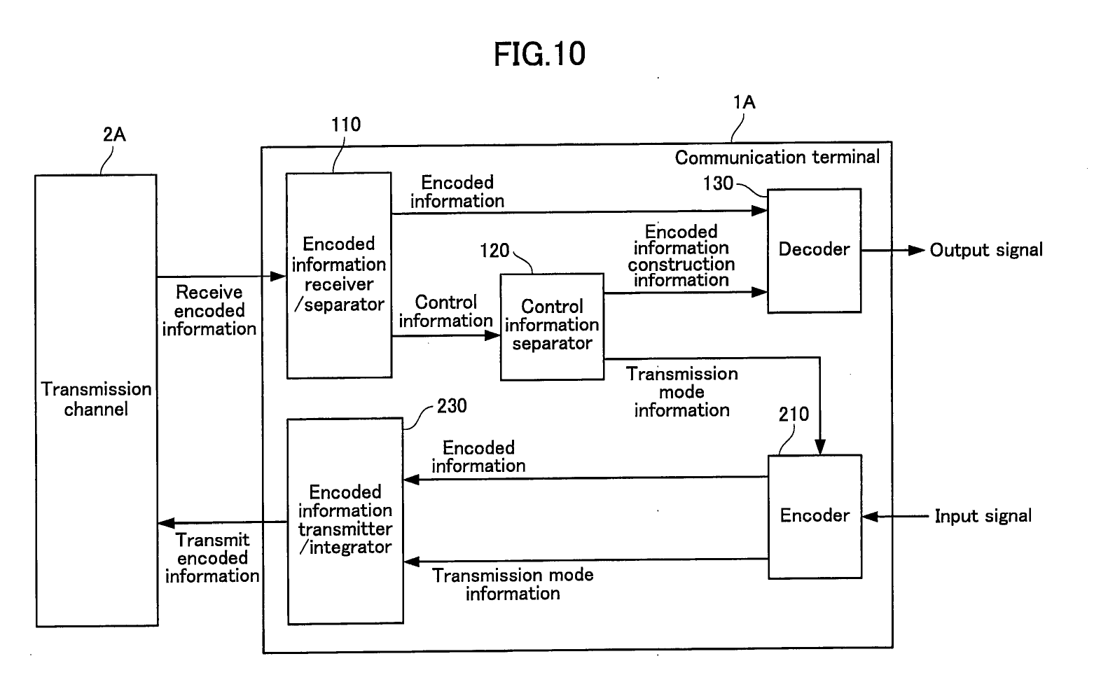

FIG. 10 is a block diagram showing the configuration of a communication terminal according to the second embodiment of the present invention. The communication terminal 1A according to the second embodiment, as shown in FIG. 10, includes an encoded information receiver/separator 110, a control information separator 120, a decoder 130, an encoder 210, and an encoded information transmitter/integrator 230. Each of communication terminals 1B to 1N has the same configuration as that of the communication terminal 1A. The configuration of each of the communication terminals 1B to 1N is thus not described. Each of the processing blocks is described below in detail.

The encoded information receiver/separator 110 receives encoded information transmitted from the relay device 10 through the transmission channels 2A to 2N and 2Z. The encoded information receiver/separator 110 then separates the received encoded information into encoded information (hereinafter referred to as a “reception encoded information”) and control information and extracts the encoded information and the control information. The encoded information receiver/separator 110 then outputs the extracted reception encoded information to the decoder 130 and outputs the extracted control information to the control information separator 120.

The control information separator 120 receives the control information from the encoded information receiver/separator 110 and analyzes the received control information. The control information separator 120 then separates the control information into encoded information configuration information and transmission mode information. The encoded information configuration information is designed to be used for decoding, while the transmission mode information is designed to be used for coding. The control information separator 120 then outputs the encoded information configuration information to the decoder 130 and outputs the transmission mode information to the encoder 210. The encoded information configuration information indicates information on a layer configuration of the encoded information. The transmission mode information is predetermined information including a transmission bit rate. That is, the control information separator 120 is designed to output, to the decoder 130, the encoded information configuration information included in the control information and output, to the encoder 210, the transmission mode information included in the control information.

The decoder 130 receives the received encoded information from the encoded information receiver/separator 110 and receives the encoded information configuration information from the control information separator 120. The decoder 130 decodes the encoded information in accordance with the received encoded information configuration information to obtain an output signal.

The encoder 210 receives an input signal such as a speech/audio signal and receives the transmission mode information from the control information separator 120. The encoder 210 encodes the transmission mode information in accordance with the received input signal. The encoder 210 then generates transmission encoded information. The encoder 210 then outputs the generated encoded information and the transmission mode information to the encoded information transmitter/separator 230.

The encoded information transmitter/separator 230 receives the encoded information and the transmission mode information from the encoder 210. The encoded information transmitter/separator 230 integrates the encoded information and the transmission mode information to generate encoded information to be transmitted. The encoded information transmitter/separator 230 then outputs the generated encoded information to the relay device 10 through the transmission channels 2A to 2N and 2Z.

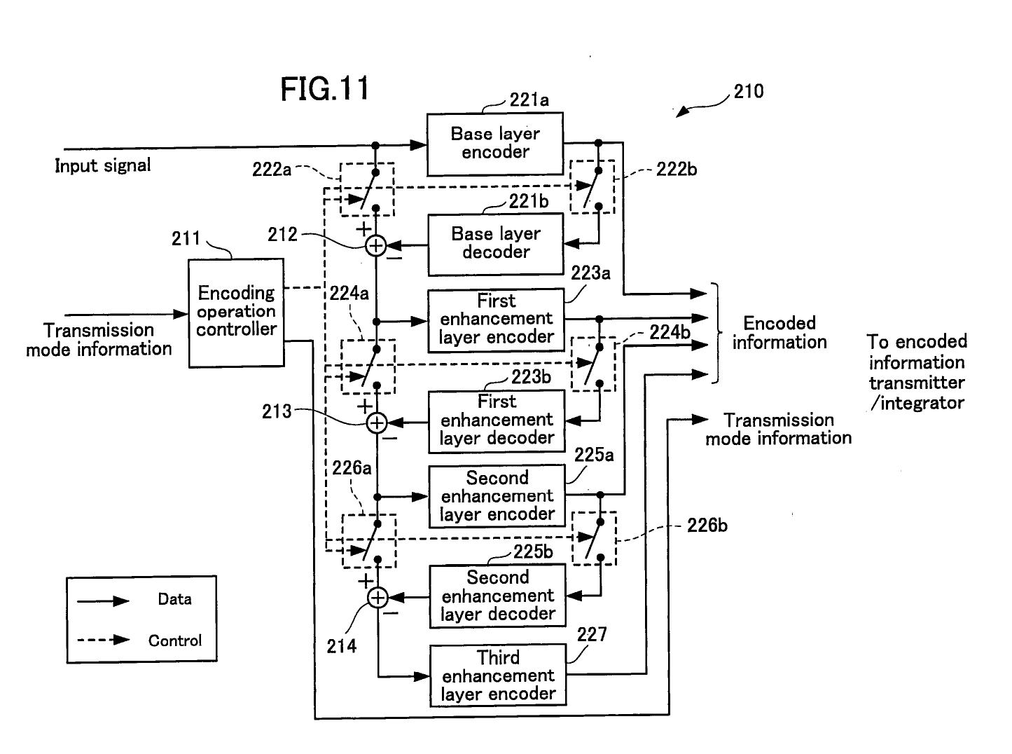

FIG. 11 is a block diagram showing the configuration of the encoder 210 according to the present embodiment. The encoder 210 partitions the input signal into pieces of data each including an N number of samples (N is a counting number) to encode each of the pieces of data including an N number of samples as a frame, the encoding being performed on a frame basis.

The encoder 210 has an encoding operation controller 211, control switches 222a, 222b, 224a, 224b, 226a, 226b, a base layer encoder 221A, a base layer decoder 221B, a first enhancement layer encoder 223a, a first enhancement layer decoder 223b, a second enhancement layer encoder 225a, a second enhancement layer decoder 225b, a third enhancement layer encoder 227, and adders 212, 213, 214.

The encoding operation controller 211 receives the transmission mode information. The encoding operation controller 211 controls the control switches 222a, 222b, 224a, 224b, 226a, 226b to turn on or turn off in accordance with the received transmission mode information. The encoding operation controller 211 controls all the control switches 222a, 222b, 224a, 224b, 226a, 226b to turn on when the transmission mode information indicates BR4.

The encoding operation controller 211 controls the control switches 222a, 222b, 224a, 224b to turn on and the control switches 226a, 226b to turn off when the transmission mode information indicates BR3. The encoding operation controller 211 controls the control switches 222a, 222b to turn on and the control switches 224a, 224b, 226a, 226b to turn off when the transmission mode information indicates BR2.

The encoding operation controller 211 controls all the control switches 222a, 222b, 224a, 224b, 226a, 226b to turn off when the transmission mode information indicates BR1. The encoding operation controller 211 is designed to output the transmission mode information to the encoded information transmitter/integrator 230. Since the encoding operation controller 211 controls the control switches 222a, 222b, 224a, 224b, 226a, 226b to turn on or turn off in accordance with the received transmission mode information to determinate a combination of encoders used to encode the input signal.

The base layer encoder 221A receives the input signal such as a speech/audio signal and encodes the input signal by using code-excited linear prediction (CELP) speech coding to generate a base layer encoded information. The base layer encoder 221A then outputs the generated base layer encoded information to the encoded information transmitter/integrator 230 and the control switch 222b. The configuration of the base layer encoder 221A is described later.

The base layer decoder 221B decodes the base layer encoded information output from the base layer encoder 221A by using the CELP speech decoding to generate a decoded base layer signal when the control switch 222b is ON. The base layer decoder 221B then outputs the generated decoded base layer signal to the adder 212. The base layer decoder 221B does not operate when the control switch 222b is OFF. The configuration of the base layer decoder 221B is described later.

The adder 212 reverses the polarity of the decoded base layer signal and adds the reversed decoded base layer signal to the input signal to generate a first differential signal. The adder 212 then outputs the generated first differential signal to the first enhancement layer encoder 223a and the control switch 224a. The adder 212 does not operate when the control switches 222a and 222b are OFF.

The first enhancement layer encoder 223a encodes the first differential signal generated by the adder 212 by using the CELP speech coding when the control switches 222a and 222b are ON to generate a first enhancement layer encoded information. The first enhancement layer encoder 223a then outputs the generated first enhancement layer encoded information to the control switch 224b and the encoded information transmitter/integrator 230. The first enhancement layer encoder 223a does not operate when the control switches 222a and 222b are OFF.

The first enhancement layer decoder 223b decodes the first enhancement layer encoded information output from the first enhancement layer encoder 223a by using the CELP speech decoding when the control switch 224b is ON to generate a decoded first enhancement layer signal. The first enhancement layer decoder 223b then outputs the generated decoded first enhancement layer signal to the adder 213. The first enhancement layer decoder 223b does not operate when the control switch 224b is OFF.

The adder 213 reverses the polarity of the decoded first enhancement layer signal and adds the reversed decoded first enhancement layer signal to the first differential signal obtained from the control switch 224a to generate a second differential signal. The adder 213 then outputs the generated second differential signal to the second enhancement layer encoder 225a. The adder 213 does not operate when the control switches 224a and 224b are OFF.

The second enhancement layer encoder 225a encodes the second differential signal output from the adder 213 by using the CELP speech coding when the control switches 224a and 224b are ON to generate a second enhancement layer encoded information. The second enhancement layer encoder 225a then outputs the generated second enhancement layer encoded information to the encoded information transmitter/integrator 230. The second enhancement layer encoder 225a does not operate when the control switches 224a and 224b are OFF.

The second enhancement layer decoder 225b decodes the second enhancement layer encoded information output from the second enhancement layer encoder 225a by using the CELP speech decoding when the control switches 226a and 226b is ON to generate a decoded second enhancement layer signal. The second enhancement layer decoder 225b then outputs the generated decoded second enhancement layer signal to the adder 214. The second enhancement layer decoder 225b does not operate when the control switch 226b is OFF.

The adder 214 reverses the polarity of the decoded second enhancement layer signal and adds the reversed decoded second enhancement layer signal to the second differential signal obtained from the control switch 226a to generate a third differential signal. The adder 214 then outputs the generated third differential signal to the third enhancement layer encoder 227. The adder 214 does not operate when the control switches 226a and 226b are OFF.

The third enhancement layer encoder 227 encodes the third differential signal output from the adder 214 by using the CELP speech coding when the control switches 226a and 226b are ON to generate encoded information (hereinafter referred to as a “third enhancement layer encoded information”). The third enhancement layer encoder 227 then outputs the generated third enhancement layer encoded information obtained by the coding to the encoded information transmitter/integrator 230. The third enhancement layer encoder 227 does not operate when the control switches 226a and 226b are OFF.

The encoded information transmitter/integrator 230 integrates the encoded information output from the base layer encoder 221A, the encoded information output from the first enhancement layer encoder 223a, the encoded information output from the second enhancement layer encoder 225a, the encoded information output from the third enhancement layer encoder 227, and the transmission mode information output from the encoding operation controller 211 to generate encoded information. The encoded information transmitter/integrator 230 then outputs the generated encoded information to the transmission channel 2A.

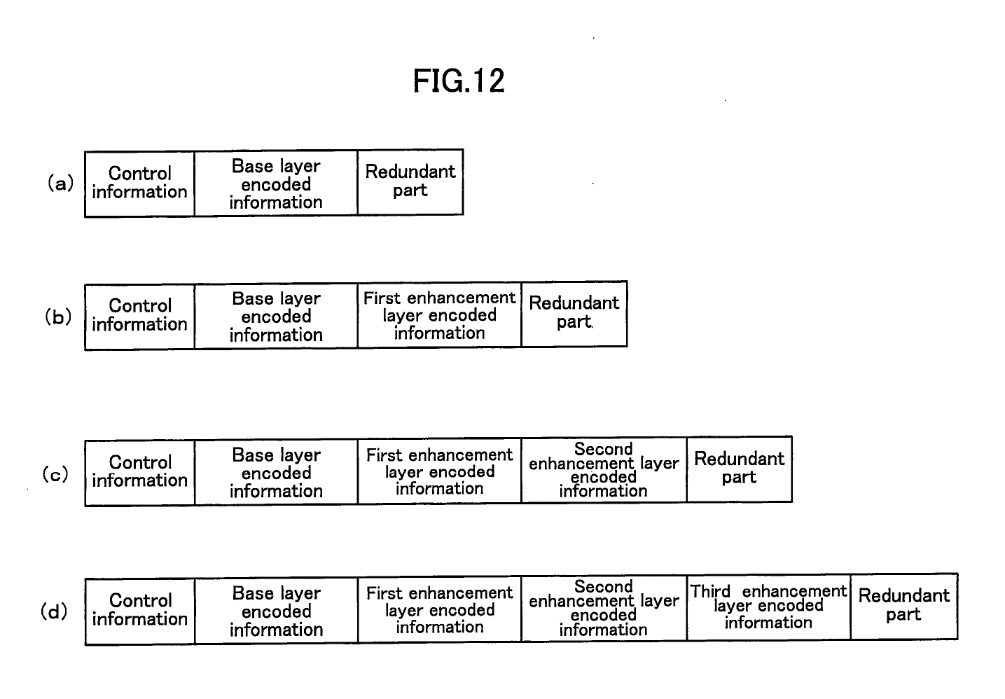

The data structure (bit stream) of the encoded information before transmission is next described with reference to FIGS. 12(a) to 12(d). When the transmission mode information indicates the transmission bit rate of BR1, the encoded information is composed of control information, a base layer encoded information, and a redundant part as shown in FIG. 12(a). When the transmission mode information indicates the transmission bit rate of BR2, the encoded information is composed of control information, a base layer encoded information, a first enhancement layer encoded information and a redundant part as shown in FIG. 12(b).

When the transmission mode information indicates the transmission bit rate of BR3, the encoded information is composed of control information, a base layer encoded information, a first enhancement layer encoded information, a second enhancement layer encoded information and a redundant part as shown in FIG. 12(c). When the transmission mode information indicates the transmission bit rate of BR4, the encoded information is composed of control information, a base layer encoded information, a first enhancement layer encoded information, a second enhancement layer encoded information, a third enhancement layer encoded information and a redundant part as shown in FIG. 12(d).

The redundant part included in each of the data structures shown in FIGS. 12(a) to 12(d) is a redundant data storage segment included in the bit stream and is used for a counter and the like to synchronize a bit stream used to detect or correct a transmission error and a packet.

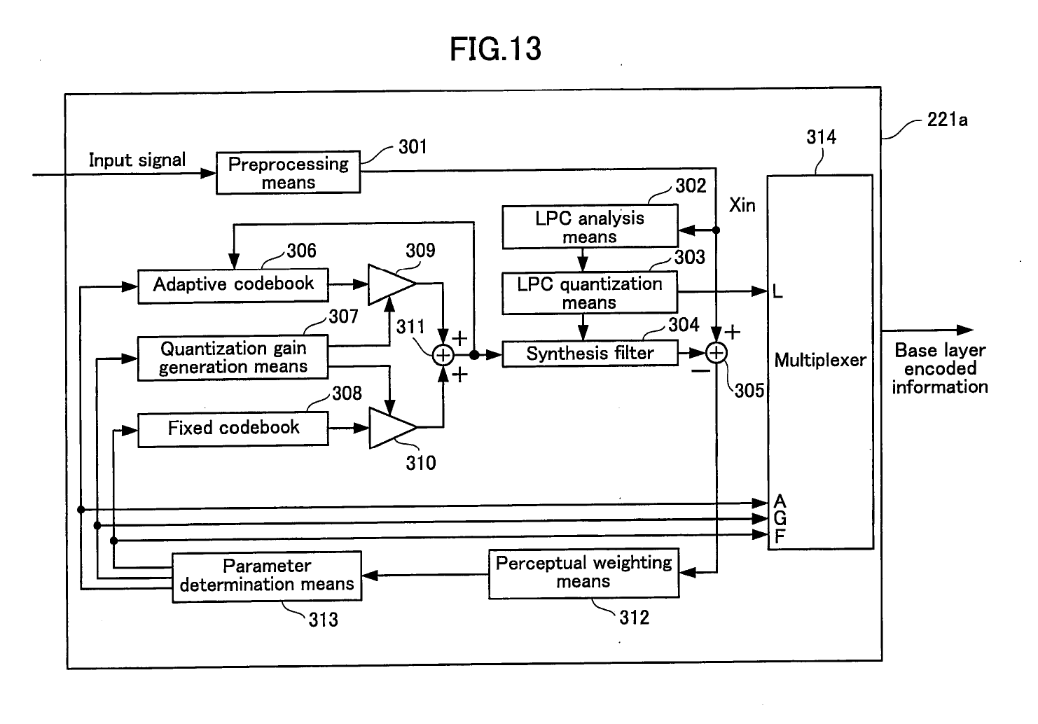

FIG. 13 is a block diagram showing the configuration of the base layer encoder 221A. The base layer encoder 221A encoding a speech/audio signal by using the CELP speech coding is described below.

The base layer encoder 221A includes preprocessing means 301, LPC analysis means 302, LPC quantization means 303, a synthesis filter 304, adders 305, 311, an adaptive codebook 306, quantization gain generating means 307, a fixed codebook 308, multipliers 309, 310, perceptual weighting means 312, parameter determination means 313, and a multiplexer 314.

The preprocessing means 301 receives an input signal that is not encoded. The preprocessing means 301 next executes processing such as high-pass filter processing for removing a direct current (DC) component from the input signal, waveform shaping processing for shaping the waveform of the input signal to improve the accuracy of the encoding executed later, and preemphasis processing. The preprocessing means 301 then outputs a signal Xin obtained by the processing to the LPC analysis means 302 and the adder 305.

The LPC analysis means 302 receives the signal Xin output from the preprocessing means 301. The LPC analysis means 302 next performs a linear prediction analysis on the signal Xin to generate a linear predictive coefficient. The LPC analysis means 302 then outputs the generated linear predictive coefficient to the LPC quantization means 303.

The LPC quantization means 303 receives the linear predictive coefficient output from the LPC analysis means 302. The LPC quantization means 303 next executes quantization processing for quantizing the linear predictive coefficient. The LPC quantization means 303 then outputs the quantized linear predictive coefficient to the synthesis filter 304. The synthesis filter 304 outputs, to the multiplexer 314, an L code indicating execution of synthesis filtering in accordance with the quantized linear predictive coefficient.

The synthesis filter 304 receives a signal output from the adder 311 and the linear prediction coefficient output from the LPC quantization means 303. The synthesis filter 304 then determines a filter coefficient used for the synthesis filtering in accordance with the quantized linear prediction coefficient. The synthesis filter 304 performs the synthesis filtering on the signal output from the adder 311 to generate a synthesized signal. The synthesis filter 304 then outputs the synthesized signal to the adder 305.

The adder 305 receives the signal Xin output from the preprocessing means 301 and the synthesized signal output from the synthesis filter 304. The adder 305 then reverses the polarity of the synthesized signal and adds the reversed synthesized signal to the signal Xin to generate an error signal. The adder 305 then outputs the generated error signal to the perceptual weighting means 312.

The adaptive codebook 306 receives an adaptive sound source vector code A output from the parameter determination means 313 described later. The adaptive codebook 306 extracts, as an adaptive sound source vector, a sample corresponding to a frame from a drive sound source (alignment) output in the past and specified in accordance with the adaptive sound source vector code A and outputs the extracted sample to the multiplier 309. The drive source output from the adder 311 in the past is stored in a buffer of the adaptive codebook 306.

The quantization gain generating means 307 receives a sound source gain code G output from the parameter determination means 313. The quantization gain generating means 307 specifies a quantized adaptive sound source gain and a quantized fixed sound source gain in accordance with the received sound source gain code G. The quantization gain generating means 307 then outputs the specified quantized adaptive sound source gain and the specified quantized fixed sound source gain to the multipliers 309 and 310, respectively. The quantized adaptive sound source gain is a gain for amplifying the adaptive sound source vector output from the adaptive codebook 306. The quantized fixed sound source gain is a gain for amplifying a fixed sound source vector output from the fixed codebook 308.

The fixed codebook 308 receives a fixed sound source vector code F output from the parameter determination 313 described later. The fixed codebook 308 then multiplies a diffusion vector by a pulse source vector having a shape specified in accordance with the received fixed sound source vector code F to generate a fixed sound source vector. The fixed codebook 308 then outputs the generated fixed sound source vector to the multiplier 310.

The multiplier 309 receives the adaptive sound source vector output from the adaptive codebook 306 and the quantized adaptive source gain output from the quantization gain generating means 307. The multiplier 309 multiplies the adaptive sound source vector by the quantized adaptive sound source gain to outputs, to the adder 311, a result obtained by multiplying the adaptive sound source vector by the quantized adaptive source gain. The multiplier 310 receives the fixed sound source vector output from the fixed codebook 308 and the quantized fixed sound source gain output from the quantization gain generating means 307. The multiplier 310 multiplies the quantized fixed sound source gain by the fixed sound source vector to output, to the adder 311, a result obtained by multiplying the quantized fixed sound source gain by the fixed sound source vector.

The adder 311 receives the adaptive sound source vector multiplied by the quantized adaptive sound source gain and output from the multiplier 309 and receives the fixed sound source vector output from the multiplier 310. The adder 311 then adds the adaptive sound source vector to the fixed sound source vector to generate a drive sound source. The adder 311 then outputs the generated drive sound source to the synthesis filter 304 and the adaptive codebook 306. The drive sound source input to the adaptive codebook 306 is stored in a buffer of the adaptive codebook 306.

The perceptual weighting means 312 receives the error signal output from the adder 305. The perceptual weighting means 312 then weights the error signal in consideration of human auditory sense to generate a coding distortion. The perceptual weighting means 312 then outputs the coding distortion to the parameter determination means 313.

The parameter determination means 313 receives the coding distortion output from the perceptual weighting means 312. The parameter determination means 313 next selects an adaptive sound source vector allowing the coding distortion to be minimized from data included in the adaptive codebook 306, a fixed sound source vector allowing the coding distortion to be minimized from data included in the fixed codebook 308, and a quantized gain allowing the coding distortion to be minimized from data included in the quantization gain generating means 307, to generate an adaptive sound source vector code A, a fixed sound source vector code F, and a sound source gain code G, respectively. The parameter determination means 313 then outputs the selected adaptive sound source vector, the selected fixed sound source vector, and the selected quantized gain to the multiplexer 314. The adaptive sound source vector code is information for specifying the adaptive sound source vector selected by the parameter determination means 313. The fixed sound source vector code is information for specifying the fixed sound source vector selected by the parameter determination means 313. The sound source gain code is information specifying the quantized adaptive sound source gain and the quantized fixed sound source gain.

The multiplexer 314 receives a code L indicative of the quantized linear predictive coefficient output from the LPC quantization means 303, the adaptive sound source vector code A, the fixed sound source vector code F, and the codebook gain code G, which are output from the parameter determination means 313. The multiplexer 314 multiplexes the code L, the adaptive sound source vector code A, and the codebook gain code G to generate and output a base layer encoded information.

The first enhancement layer encoder 223a, the second enhancement layer encoder 225a, and the third enhancement layer encoder 227 shown in FIG. 11 are the same in configuration as the base layer encoder 221A, and description thereof is omitted. It should be noted that the signals input to the encoders 223a, 225a, 227 are different from the encoded information output from the encoders 223a, 225a, 227, respectively.

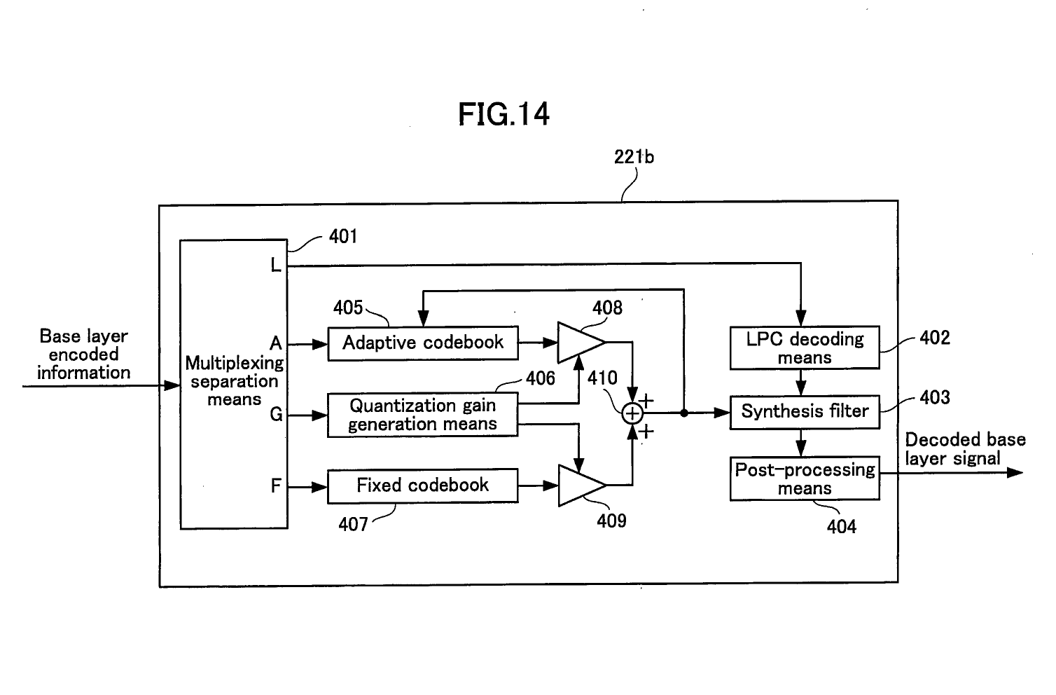

FIG. 14 is a block diagram showing the configuration of the base layer decoder 221B according to the present embodiment. The base layer decoder 221B decoding a speech/audio signal by using CELP speech decoding is described below as an example.

As shown in FIG. 14, the base layer decoder 221B has multiplexing/separation means 401, LPC decoding means 402, a synthesis filter 403, post-processing means 404, an adaptive codebook 405, quantization gain generating means 406, a fixed codebook 407, multipliers 408, 409, and an adder 410.

The multiplexing/separation means 401 receives the base layer encoded information input to the base layer decoder 221B. The multiplexing/separation means 401 next separates the base layer encoded information into codes L, A, G, F. The multiplexing/separation means 401 then outputs the codes L, A, G, and F to the LPC decoding means 402, the adaptive codebook 405, the quantization gain generating means 406, and the fixed codebook 407, respectively.

The LPC decoding means 402 receives the code L output from the multiplexing/separation means 401. The LPC decoding means 402 next decodes the quantized linear predictive coefficient in accordance with the code L. The LPC decoding means 402 outputs the decoded quantized linear predictive coefficient to the synthesis filter 403.

The adaptive codebook 405 receives the code A output from the multiplexing/separation means 401. The adaptive codebook 405 selects a sample corresponding to a frame of a drive sound source specified in the code A from a past drive sound source stored. The adaptive codebook 405 then outputs the selected sample as an adaptive sound source vector.

The quantization gain generating means 406 receives the codebook gain code G output from the multiplexing/separation means 401. The quantization gain generating means 406 then decodes the quantized adaptive sound source gain and the quantized fixed sound source gain specified in the codebook gain code G. The quantization gain generating means 406 then outputs the adaptive sound source gain to the multiplier 408 and outputs the quantized fixed sound source gain to the multiplier 409.

The fixed codebook 407 receives the code F output from the multiplexing/separation means 401. The fixed codebook 407 then generates a fixed sound source vector specified in the code F and outputs the generated fixed sound source vector to the multiplier 409.

The multiplier 408 receives the adaptive sound source vector output from the adaptive codebook 405 and the quantized adaptive sound source gain output from the quantization gain generating means 406. The multiplier 408 multiplies the adaptive sound source vector by the quantized adaptive sound source gain to output the multiplied adaptive sound source vector to the adder 410.

The multiplier 409 receives the fixed sound source vector output from the fixed codebook 407 and receives the quantized fixed sound source gain output from the quantization gain generating means 406. The multiplier 409 then multiplies the fixed sound source vector by the quantized fixed sound source gain to output the multiplied fixed sound source vector to the adder 410.

The adder 410 adds the gain-multiplied adaptive sound source vector output from the multiplier 408 to the gain-multiplied fixed sound source vector output from the multiplier 409 to generate a drive sound source. The adder 410 then outputs the generated drive sound source to the synthesis filter 403 and the adaptive codebook 405.

The synthesis filter 403 receives the quantized linear predictive coefficient output from the LPC decoding means 402 and receives the drive sound source output from the adder 410. The synthesis filter 403 determines a filter coefficient in accordance with the quantized linear predictive coefficient. The synthesis filter 403 performs synthesis filtering on the received drive sound source by use of the filter coefficient to output a signal obtained (synthesized) to the post-processing means 404.

The post-processing means 404 receives the signal output from the synthesis filter 403. The post-processing means 404 then executes processing on the received signal to improve the subjective sound quality and reduce stationary noise, the processing including formant emphasis processing and pitch emphasis processing. The post-processing means 404 then outputs the processed signal as a decoded base layer signal.

The first enhancement layer decoder 223b and the second enhancement layer decoder 225b as shown in FIG. 11 are the same in configuration as the base layer decoder 221B, and the description thereof is omitted. It should be noted that the types of the signals input to the first enhancement layer decoder 223b and to the second enhancement layer decoder 225b are different from the types of decoded signals output from the first enhancement layer decoder 223b and from the second enhancement layer decoder 225b, respectively.

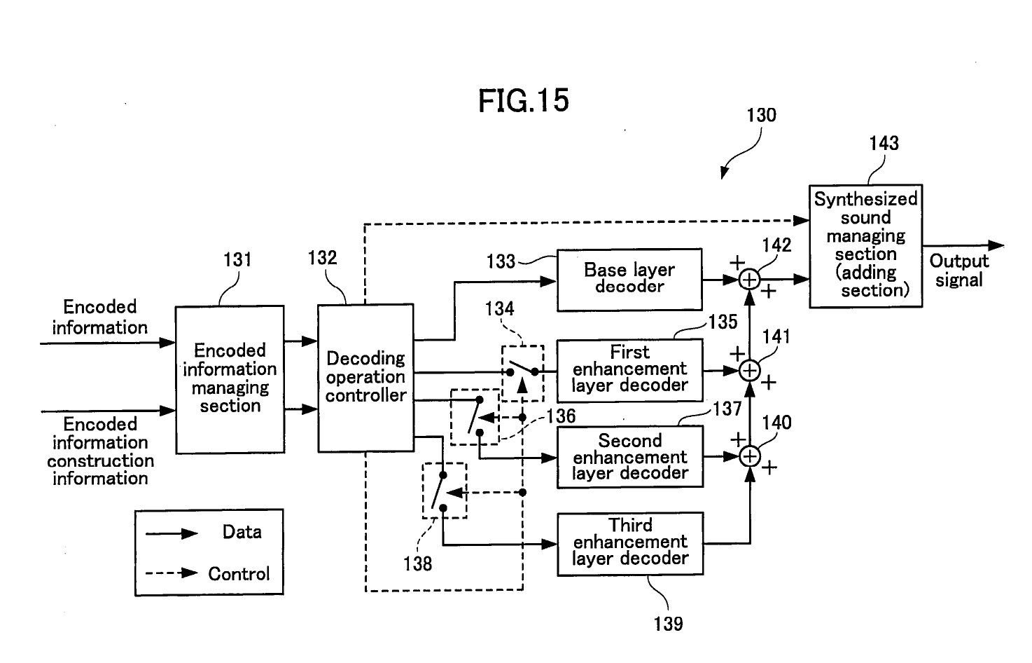

FIG. 15 is a block diagram showing the configuration of the decoder 130 according to the present embodiment. The decoder 130 decoding a speech/audio signal by using the CELP speech decoding is described below as an example.

The decoder 130 includes an encoded information managing section 131, a decoding operation controller 132, a base layer decoder 133, a first enhancement layer decoder 135, a second expansion decoder 137, a third expansion decoder 139, control switches 134, 136, 138, adders 140 to 142, and a synthesized sound managing section 143.

The encoded information managing section 131 receives the encoded information output from the encoded information receiver/separator 110 and receives the encoded information configuration information output from the control information separator 120. The encoded information managing section 131 causes the received encoded information and the control information to be stored in an internal memory provided in the encoded information managing section 131 until a predetermined amount of encoded information are received, in accordance with the received encoded information configuration information. Specifically, the encoded information managing section 131 causes the received encoded information to be stored in the internal memory until the predetermined amount of encoded information transmitted from all communication terminals 1A to 1N and the like participating in multi-party communications are received. When the encoded information managing section 131 receives the predetermined amount of encoded information, the encoded information managing section 131 outputs the encoded information and the encoded information configuration information stored in the internal memory to the decoding operation controller 132.

The decoding operation controller 132 receives the encoded information and the encoded information configuration information from the encoded information managing section 131. The decoding operation controller 132 controls the control switches 134, 136, 138 to cause the control switches 134, 136, 138 to turn on or off for each of the encoded information transmitted from the communication terminals 1A to 1N and the like, in accordance with the encoded information configuration information, to output a signal to a corresponding one of the base layer decoder 133, the first enhancement layer decoder 135, the second enhancement layer decoder 137, and the third enhancement layer decoder 139.

The decoding operation controller 132 refers to the number of the occupation layers (L1, L2, . . . ) indicated by the encoded information configuration information obtained by the encoded information managing section 131 for each of the communication terminals 1A to 1N and the like. When the number of the occupation layers is 1 (when the encoded information configuration information indicates that the number of the occupation layers is L1), the decoding operation controller 132 controls the control switches 134, 136, 138 to cause the control switches 134, 136, 138 to turn off and outputs, to the base layer decoder 133, encoded information transmitted from the corresponding communication terminal. When the number of the occupation layers is 2 (when the encoded information configuration information indicates that the number of the occupation layers is L2), the decoding operation controller 132 controls the control switches 134, 136, 138 to cause the control switch 134 to turn on and to cause the control switches 136, 138 to turn off. The decoding operation controller 132 then outputs encoded information transmitted from the corresponding communication terminal to the base layer decoder 133 and the first enhancement layer decoder 135 in the order from the lower layer decoder. When the number of the occupation layers is 3 (when the encoded information configuration information indicates that the number of the occupation layers is L3), the decoding operation controller 132 controls the control switches 134, 136, 138 to cause the control switches 134, 136 to turn on and to cause the control switches 138 to turn off. Then, the decoding operation controller 132 outputs encoded information transmitted from the corresponding communication terminal to the base layer decoder 133, the first enhancement layer decoder 135, and the second enhancement layer decoder 137 in the order from the lowest layer decoder. When the number of the occupation layers is 4 (when the encoded information configuration information indicates that the number of the occupation layers is L4), the decoding operation controller 132 controls the control switches 134, 136, 138 to cause the control switches 134, 136, 138 to turn on. The decoding operation controller 132 then outputs encoded information transmitted from the corresponding communication terminal to the base layer decoder 133, the first enhancement layer decoder 135, the second enhancement layer decoder 137, and the third enhancement layer decoder 139.

The decoding operation controller 132 is designed to transmit a control signal to the synthesized sound managing section 143 to control an operation of the synthesized sound managing section 143 until all the encoded information transmitted from the communication terminals 1A to 1N and the like are decoded and stored in the internal memory.

The following description is made of an example in which the encoded information configuration information received by the decoding operation controller 132 of the communication terminal 1A indicates “B:L2 (base, enh1) C:L2 (enh2, enh3)” under the condition that communications between three terminals (communication terminals 1A, 1B and 1C) are performed by using a scalable communications technique with four layers. In this case, the decoding operation controller 132 controls the control switches 134, 136, 138 to cause the control switch 134 to turn on and to cause the control switches 136, 138 to turn off. The decoding operation controller 132 then outputs the base layer encoded information that is encoded information transmitted from the communication terminal 1B to the base layer decoder 133, and outputs the first enhancement layer encoded information to the first enhancement layer decoder 135. The decoding operation controller 132 also outputs a control signal to the synthesized sound managing section 143 to cause the synthesized sound managing section 143 to store a decoded signal transmitted from each of the communication terminals 1B and 1C and decoded by each of the base layer decoder 133 and the first enhancement layer decoder 135. The decoding operation controller 132 next controls the control switches 134, 136, 138 to cause the control switch 134 to turn on and to cause the control switches 136, 138 to turn off. The decoding operation controller 132 then outputs the second enhancement layer encoded information that is encoded information transmitted from the communication terminal 1C to the base layer decoder 133, and outputs the third enhancement layer encoded information to the first enhancement layer decoder 135.

The base layer decoder 133 decodes an encoded information such as the base layer encoded information output from the decoding operation controller 132 by using the CELP speech decoding, and outputs, to the adder 142, a decoded signal (hereinafter referred to as a “decoded base layer signal”) obtained by decoding the encoded information.

The first enhancement layer decoder 135 decodes an encoded information such as the first enhancement layer encoded information output from the decoding operation controller 132 by using the CELP speech decoding, and then outputs a decoded signal (hereinafter, referred to as a “decoded first enhancement layer signal”) obtained by decoding the encoded information to the adder 141, when the control switch 134 is ON. The first enhancement layer decoder 135 does not operate when the control switch 134 is OFF.

The second enhancement layer decoder 137 decodes an encoded information such as the second enhancement layer encoded information output from the decoding operation controller 132 by using the CELP speech decoding, and then outputs a decoded signal (hereinafter, referred to as a “decoded second enhancement layer signal”) obtained by decoding the encoded information to the adder 140, when the control switch 136 is ON. The second enhancement layer decoder 137 does not operate when the control switch 136 is OFF.

The third enhancement layer decoder 139 decodes encoded information such as the third enhancement layer encoded information output from the decoding operation controller 132 by using the CELP speech decoding, and then outputs a decoded signal (hereinafter, referred to as a “decoded third enhancement layer signal”) obtained by decoding the encoded information to the adder 140, when the control switch 138 is ON. The third enhancement layer decoder 139 does not operate when the control switch 138 is OFF.

The adder 140 adds the decoded third enhancement layer signal output from the third enhancement layer decoder 139 to the decoded second enhancement layer signal output from the second enhancement layer decoder 137 to output a signal obtained by adding the decoded third enhancement layer signal to the decoded second enhancement layer signal to the adder 141, when the control switches 136, 138 are ON. The adder 140 outputs the decoded second enhancement layer output from the second enhancement layer decoder 137 to the adder 141 when the control switch 136 is ON and the control switch 138 is OFF. The adder 140 does not operate when the control switches 136, 138 are OFF.

The adder 141 adds the decoded second enhancement layer signal output from the second enhancement layer decoder 137 to the decoded first enhancement layer signal output from the first enhancement layer decoder 135 to output, to the adder 142, a signal obtained by adding the decoded second enhancement layer signal to the decoded first enhancement layer signal, when the control switches 134, 136 are ON. The adder 141 outputs the decoded first enhancement layer output from the first enhancement layer decoder 135 to the adder 142 when the control switch 136 is OFF and the control switch 134 is ON. The adder 141 does not operate when the control switches 134, 136 are OFF.

The adder 142 adds the decoded signal output from the adder 141 to the decoded base layer signal output from the base layer decoder 133 to output a signal obtained by the addition to the synthesized sound managing section 143 when the control switch 134 is ON. The adder 142 outputs the decoded base layer signal received from the base layer decoder 133 to the synthesized sound managing section 143 when the control switch 134 is OFF.

The synthesized sound managing section 143 receives the decoded signal output from the adder 142 and stores the received decoded signal in an internal memory provided in the synthesized sound managing section 143 in accordance with control of the decoding operation controller 132. The synthesized sound managing section 143 overlaps and adds multiple decoded signals stored in the internal memory to output a signal obtained by the addition as an output signal.

The synthesized sound managing section 143 receives, from the decoding operation controller 132, a signal that indicates the number of communication terminals and constitutes encoded information transmitted from the controller (relay device) as a control signal. The synthesized sound managing section 143 causes the decoded signals corresponding to the number of the communication terminals to be stored in the internal memory. The synthesized sound managing section 143 then overlaps and adds all the decoded signals stored in the internal memory to output a signal obtained by the addition.

The base layer decoder 133, the first enhancement layer decoder 135, the second enhancement layer decoder 137, and the third enhancement layer decoder 139 are the same in configuration as the base layer decoder 221B described above. The base layer decoder 133, the first enhancement layer decoder 135, the second enhancement layer decoder 137, and the third enhancement layer decoder 139 are different from the base layer decoder 221B only in the type of an encoded information to be input and in the type of a signal to be output. Thus, the configurations of the base layer decoder 133, the first enhancement layer decoder 135, the second enhancement layer decoder 137, and the third enhancement layer decoder 139 are not described.

The communication terminal according to the present embodiment is designed to reconstruct received encoded information and transmit the reconstructed encoded information without decoding the encoded information, as described above. This prevents an increase in cost necessary for processing, compared with the conventional communication terminal, communication method and the like. The communication terminal makes it possible to achieve a multi-party communication system capable of suppressing a deterioration of the quality of a sound obtained by decoding a signal.

The communication terminal according to the present embodiment is designed to decode information encoded in each of the layers in accordance with the control information. The communication terminal is capable of decoding encoded information transmitted from a different communication terminal and integrated in a different layer.

In addition, the communication terminal is capable of decoding the encoded information under the condition that the transmission bit rate is decreased since the communication terminal is designed to decode the information encoded in each of the layers.

The communication terminal having the configuration with the four layers is described above to easily understand the above embodiments. The present invention, however, is not limited to the configuration with the four layers. The number of the layers is not limited as long as a residual signal representing a difference between an input signal and an output signal of a lower layer is encoded in a higher layer in a coding or decoding method using hierarchical layers.

According to the present invention, the number of communication terminals capable of performing simultaneous multi-party communications is not limited. The present invention may be applied to multi-party communications between communication terminals, the number of which is more than the number of layers in which a scalable coding technique is used, by combining with a technique for decoding encoded information transmitted from each of the communication terminals, the number of which is more than the number of the layers, overlapping the decoded encoded information and a decoded signal obtained by decoding encoded information transmitted from another one of the communication terminals, and encoding a signal obtained by the overlapping.

In the above description, the layers are evenly assigned to communication terminals 1A to 1N and the like to easily understand the present embodiment. The present invention, however, is not limited to the above-described method of the assignments of the layers to the communication terminals 1A to 1N and the like. The present invention may be applied to a method for assigning a layer to a terminal based on a condition, such as a method for preferentially assigning a layer to a communication terminal transmitting a high level of a speech/audio signal and a method for preferentially assigning a layer to a communication terminal connected to the relay device through a line in good condition, which results in flexible multi-party communications.

In the description above, each of the communication terminals 1A to 1N and the like is designed to transmit a request for releasing a line connection when participating in multi-party communications and canceling the participation of the multi-party communications, especially when canceling the participation of multi-party communications.

The present invention, however, is not limited to the above description. Each of the communication terminals 1A to 1N and the like may forcibly cause another one of the communication terminals 1A to 1N and the like to cancel the participation of the multi-party communications.

### INDUSTRIAL APPLICABILITY

The relay device, the communication terminal, the signal decoder, the method for processing a signal, and the program for processing a signal, according to the present invention, make it possible to achieve a multi-party communication system capable of preventing a deterioration of the quality of a decoded sound signal, without an increase in cost necessary for the processing. The relay device, the communication terminal, the signal decoder, the method for processing a signal, and the program for processing a signal, according to the present invention, are useful for multi-party communications.

What is claimed is:

1. A relay device comprising:
a receiver for receiving encoded information transmitted from a plurality of communication terminals participating in multi-party communications and encoded on a layer basis in a plurality of layers by scalable coding;
a reconstruction processor for generating control information used to combine, on a layer basis, said encoded information received by said receiver; and
an integrator/transmitter for integrating, on a layer basis, said encoded information received by said receiver from said plurality of communication terminals, in accordance with said control information generated by said reconstruction processor.

2. A relay device as set forth in claim 1, wherein
said reconstruction processor has a control parameter storage section for storing a control parameter set for each of said plurality of communication terminals participating in said multi-party communications, said control parameter including a transmission bit rate of a signal transmitted in the past, and
said reconstruction processor generates said control information used to combine said encoded information to be transmitted to said plurality of communication terminals, in accordance with said control parameter stored in said control parameter storage section.

3. A relay device as set forth in claim 2, wherein
said reconstruction processor sets said control parameter stored in said control parameter storage section in accordance with a level of a speech/audio signal to be reproduced based on said encoded information transmitted from said plurality of communication terminals and with information relating to a communication condition including a status of a line used to communicate said relay device with said plurality of communication terminals.

4. A relay device as set forth in claim 2, wherein
said reconstruction processor updates said control parameter stored in said control parameter storage section when a communication terminal other than said plurality of communication terminals participates in said multi-party communications or when any of said plurality of communication terminals participating in said multi-party communications cancel the participation of said multi-party communications.

5. A relay device as set forth in claim 2, wherein
said reconstruction processor selects said encoded information encoded on a layer basis in a predetermined number of layers including a base layer from said encoded information received from the plurality of communication terminals in accordance with said control parameter stored in said control parameter and combine the selected encoded information.

6. A relay device as set forth in claim 2, wherein
each of said plurality of communication terminals includes an encoded information storage section for sequentially storing said encoded information transmitted by each of said plurality of communication terminals in each of time zones, and
said encoded information storage section outputs, to said reconstruction processor, said encoded information sequentially stored in said encoded information storage section and not output to the reconstruction processor when said encoded information storage section receives said encoded information transmitted in the same time zone from any two or more of said plurality of communication terminals participating in said multi-party communications.

7. A relay device as set forth in claim 1, wherein
any one of said plurality of communication terminals, which attempts to cause a communication terminal other than said plurality of communication terminals to participate in said multi-party communications, is connected to said communication terminal other than said plurality of communication terminals through a line other than a line used for said multi-party communications to cause said communication terminal other than said plurality of communication terminals to participate in said multi-party communications.

8. A relay device as set forth in claim 1, wherein
any one of said plurality of communication terminals participating in said multi-party communications is connected to a communication terminal other than said plurality of communication terminals through a line other than a line used for said multi-party communications to communicate said any one of said plurality of communication terminals with said communication terminal other than said plurality of communication terminals.

9. A communication terminal comprising:
a receiver for receiving information encoded on a layer basis in a plurality of layers by scalable coding;
a decoder for decoding a speech/audio signal by scalable decoding in accordance with control information included in said encoded information received by said receiver,
an encoder for encoding a speech/audio signal by scalable coding in accordance with said control information included in said encoded information received by said receiver; and
a transmitter for transmitting said encoded information obtained by encoding said speech/audio signal by said encoder.

10. A signal processor comprising:
an encoded information separator for separating information encoded on a layer basis in a plurality of layers by scalable coding into an encoded information of each layer and control information; and
a decoder for decoding said encoded information on a layer basis in accordance with said control information.

11. A signal processor as set forth in claim 10, wherein
said decoder decodes said information encoded on a layer basis in a predetermined number of layers including a base layer.

12. A method for processing a signal, said method comprising:
a receiving step of receiving encoded information transmitted from a plurality of communication terminals participating in multi-party communications and encoded on a layer basis in a plurality of layers by scalable coding by use of a receiver;
a reconstruction step of generating control information used to combine, on a layer basis, said encoded information received from said plurality of communication terminals in said receiving step, by using a reconstruction processor;
an integration step of combining and integrating said encoded information on a layer basis by using an integrator/transmitter; and
a transmission step of transmitting said information encoded on a layer basis in said plurality of layers and integrated in said integration step by using said integrator/transmitter.

13. A program for processing a signal which causes a computer to execute:
a receiving step of receiving encoded information transmitted from a plurality of communication terminals participating in multi-party communications and encoded on a layer basis in a plurality of layers by scalable coding;
a reconstruction step of generating control information used to combine, on a layer basis, said encoded information received from said plurality of communication terminals in said receiving step;
an integration step of combining and integrating, on a layer basis, said encoded information received from said plurality of communication terminals in said receiving step and encoded on a layer basis in said plurality of layers; and
a transmission step of transmitting information encoded on a layer basis and in said plurality of layers and integrated in said integration step.
